(19) United States
(12) Patent Application Publication
(10) Pub. No.: US 2025/0245391 A1
(43) Pub. Date: Jul. 31, 2025

(54) Method and system of quantitative derivation for on-line evaluation layered model of concrete dam operation performance, and storage medium

(71) Applicants: HUANENG LANCANG RIVER HYDROPOWER INC., Kunming (CN); HOHAI UNIVERSITY, Nanjing City (CN)

(72) Inventors: Hao Chen, Kunming (CN); Zuobin Yang, Kunming (CN); Ji Lu, Kunming (CN); Daming Zhu, Kunming (CN); Yan Xiang, Kunming (CN); Guo Li, Kunming (CN); Yingchi Mao, Kunming (CN); Zicheng Wang, Kunming (CN); Guangze Shen, Kunming (CN); Honglin Xie, Kunming (CN); Libing Zhang, Kunming (CN); Xuexing Cao, Kunming (CN); Ran Li, Kunming (CN); Liqiao Lu, Kunming (CN); Shiqi Wang, Kunming (CN); Shuai Zhang, Kunming (CN); Jia Feng, Kunming (CN); Xing Lv, Kunming (CN); Yitong Chen, Kunming (CN); Guineng Liao, Kunming (CN); Xinxin Peng, Kunming (CN); Zhen Guan, Kunming (CN); Bin Tan, Kunming (CN)

(73) Assignees: HUANENG LANCANG RIVER HYDROPOWER INC., Kunming (CN); HOHAI UNIVERSITY, Nanjing City (CN)

(21) Appl. No.: 18/831,454

(22) Filed: Jan. 24, 2025

(30) Foreign Application Priority Data
Jan. 24, 2024 (CN) 202410104570.9

(51) Int. Cl. G06F 30/13; G06F 30/27

(52) U.S. Cl. CPC G06F 30/13; G06F 30/27

(57) ABSTRACT

The present application proposes a method and system for quantitative derivation of an on-line evaluation layered model for evaluating concrete dam operation performance, and a storage medium, and relates to the technical field of dam operation safety monitoring and management. A logic architecture of quantitative derivation of the concrete dam operation performance mainly has two aspects, a longitudinal dimension and a transverse dimension. The longitudinal dimension is the principal line of assessing longitudinal evaluation of the on-line evaluation layered model, and an analysis idea of the concrete dam from local to global and from details to whole is objectively reflected from six levels of monitoring data, diagnosis methods, monitored items, evaluation indicators, key parts and an overall project. The transverse dimension is an element set for evaluating the concrete dam operation performance, comparison of importance degrees of various assessment elements at the same level is conducted, and at the same time, an association relationship between the elements at the same level is established. Therefore, by means of comparison of the elements in the transverse dimension and recursion of the various levels in the longitudinal dimension, the overall concrete dam operation performance is automatically and rapidly evaluated, and grading results of an operation state of a concrete dam are given through a safety assessment set, such that safety evaluation of the concrete dam operation performance is more systematic and comprehensive in analysis method and engineering part, and more explicit and reliable in derivation logic and evaluation efficiency.

### CROSS REFERENCE TO RELATED APPLICATIONS

The present application claims priority to the Chinese patent application No. 202410104570.9 filed on Jan. 24, 2024 to the China Patent Office, and entitled “METHOD AND SYSTEM OF QUANTITATIVE DERIVATION FOR ON-LINE EVALUATION LAYERED MODEL OF CONCRETE DAM OPERATION PERFORMANCE, AND STORAGE MEDIUM”, the entire content of which is incorporated herein by reference.

### TECHNICAL FIELD

The present application relates to the technical field of monitoring and management for operation safety of dams, in particular to a method, apparatus and system for quantitative derivation of an on-line evaluation layered model for evaluating concrete dam operation performance, a storage medium and a computer program product.

### BACKGROUND

With the enrichment of dam monitoring technological means and the increasing frequency of automated monitoring, monitoring data has not only significantly increased in quantity, but also continued to grow in dimension. Current dam safety assessment is mainly regular post-assessment, that is, after a period of operation of a dam (week, month, quarter, year, etc.), working condition monitoring data and on-site inspection materials of the dam during the period are compiled, statistical models or other models are established at key monitoring points of monitored items such as deformation, seepage, stress-strain and temperature of the dam, the change trend of data at typical monitoring points in key parts is analyzed, and combined with experience and judgment of on-site operation and maintenance personnel and hydraulic technology experts, the operation safety of the dam is analyzed and assessed.

The operation period of the concrete dam is comprehensively influenced by multiple factors such as loads, structural types, terrain and geological conditions, and physical and mechanical properties of materials. Relying solely on traditional monitoring data analysis methods is difficult to make timely and comprehensive analysis of the overall operation performance of the concrete dam. Therefore, there is an urgent need for a more reliable method for quantitative derivation of an on-line evaluation layered model for evaluating concrete dam operation performance.

### SUMMARY OF THE INVENTION

The present application aims to solve one of the technical problems in the related art at least to a certain extent.

For this purpose, a first objective of the present application is to propose a method for quantitative derivation of an on-line evaluation layered model for evaluating concrete dam operation performance. Rapid and intelligent assessment of the concrete dam operation performance is achieved through operation performance evaluation in a longitudinal dimension and a transverse dimension, and safety evaluation of the concrete dam operation performance is more systematic, comprehensive, accurate and reliable.

A second objective of the present application is to propose an apparatus for quantitative derivation of an on-line evaluation layered model for evaluating concrete dam operation performance.

A third objective of the present application is to propose a system for quantitative derivation of an on-line evaluation layered model for evaluating concrete dam operation performance.

A fourth objective of the present application is to propose a non-transitory computer-readable storage medium having computer instructions stored therein.

A fifth objective of the present application is to propose a computer program product.

For implementing the above objectives, an embodiment of a first aspect of the present application proposes a method for quantitative derivation of an on-line evaluation layered model for evaluating concrete dam operation performance, and the method includes:
acquiring the on-line evaluation layered model for evaluating concrete dam operation performance and a safety assessment set for representing the concrete dam operation performance; wherein
the monitoring data layer is configured to acquire basic data of the concrete dam operation performance composed of engineering safety monitoring data, walkaround inspection defect data and geophysical prospecting detection result data;
the diagnosis method layer is configured to establish a first membership degree matrix of basic data contained in various same-type evaluation indicator sub-items in relation with the safety assessment set according to the evaluation indicators set up by the evaluation indicator layer, and construct an evaluation indicator sub-item comprehensive evaluation matrix according to the first membership degree matrix and a first weight matrix generated by performing weight assignment based on a concern extent about the concrete dam operation performance associated with each of the various same-type evaluation indicator sub-items;
the evaluation indicator layer is configured to determine the evaluation indicators in combination with structural characteristics and working condition state assessment of the concrete dam, and establish a second membership degree matrix of the evaluation indicator sub-item comprehensive evaluation matrix corresponding to each same-type evaluation indicator sub-item contained in each of the various evaluation indicators in relation with the safety assessment set, so as to construct an evaluation indicator comprehensive evaluation matrix based on the second membership degree matrix and a second weight matrix in which various evaluation indicator items are the same in concern extent and equal in weight;
the monitored item layer is configured to acquire evaluation indicator comprehensive evaluation matrices corresponding to evaluation indicators contained in various monitored items, and establish a third membership degree matrix of the evaluation indicator comprehensive evaluation matrices in relation with the safety assessment set, so as to construct a monitored item comprehensive evaluation matrix based on the third membership degree matrix and a third weight matrix in which various monitored items are the same in concern extent and equal in weight; and
the key part layer is configured to acquire monitored item comprehensive evaluation matrices corresponding to the monitored items contained in various key parts, and establish a fourth membership degree matrix of the monitored item comprehensive evaluation matrices in relation with the safety assessment set, so as to construct a key part comprehensive evaluation matrix based on the fourth membership degree matrix and a fourth weight matrix in which various key parts are the same in concern extent and equal in weight; and
determining overall operation performance of the concrete dam in an overall project layer according to various key part comprehensive evaluation matrices.

For implementing the above objectives, an embodiment of a second aspect of the present application proposes an apparatus for quantitative derivation of an on-line evaluation layered model for evaluating concrete dam operation performance, and the apparatus includes:
an acquiring module, configured to acquire the on-line evaluation layered model for evaluating concrete dam operation performance and a safety assessment set for representing the concrete dam operation performance; wherein
the monitoring data layer is configured to acquire basic data of the concrete dam operation performance composed of engineering safety monitoring data, walkaround inspection defect data and geophysical prospecting detection result data;
the diagnosis method layer is configured to establish a first membership degree matrix of basic data contained in various same-type evaluation indicator sub-items in relation with the safety assessment set according to the evaluation indicators set up by the evaluation indicator layer, and construct an evaluation indicator sub-item comprehensive evaluation matrix according to the first membership degree matrix and a first weight matrix generated by performing weight assignment based on a concern extent about the concrete dam operation performance associated with each of the various same-type evaluation indicator sub-items;
the evaluation indicator layer is configured to determine the evaluation indicators in combination with structural characteristics and working condition state assessment of the concrete dam, and establish a second membership degree matrix of the evaluation indicator sub-item comprehensive evaluation matrix corresponding to each same-type evaluation indicator sub-item contained in each of the various evaluation indicators in relation with the safety assessment set, so as to construct an evaluation indicator comprehensive evaluation matrix based on the second membership degree matrix and a second weight matrix in which various evaluation indicator items are the same in concern extent and equal in weight;
the monitored item layer is configured to acquire evaluation indicator comprehensive evaluation matrices corresponding to evaluation indicators contained in various monitored items, and establish a third membership degree matrix of the evaluation indicator comprehensive evaluation matrices in relation with the safety assessment set, so as to construct a monitored item comprehensive evaluation matrix based on the third membership degree matrix and a third weight matrix in which various monitored items are the same in concern extent and equal in weight; and
the key part layer is configured to acquire monitored item comprehensive evaluation matrices corresponding to the monitored items contained in various key parts, and establish a fourth membership degree matrix of the monitored item comprehensive evaluation matrices in relation with the safety assessment set, so as to construct a key part comprehensive evaluation matrix based on the fourth membership degree matrix and a fourth weight matrix in which various key parts are the same in concern extent and equal in weight; and
a determining module, configured to determine overall operation performance of the concrete dam in the overall project layer according to various key part comprehensive evaluation matrices.

For implementing the above objectives, an embodiment of a third aspect of the present application proposes a system for quantitative derivation of an on-line evaluation layered model for evaluating concrete dam operation performance, including: at least one processor; and a memory in communication connection with the at least one processor; wherein the memory has instructions stored therein that can be executed by the at least one processor, and the instructions, when executed by the at least one processor, causes the at least one processor to execute the method described in the first aspect.

For implementing the above objectives, an embodiment of a fourth aspect of the present application proposes a non-transitory computer-readable storage medium having computer instructions stored therein, wherein the computer instructions are configured to cause a computer to execute the method described in the first aspect.

According to the method, apparatus and system for quantitative derivation of the on-line evaluation layered model for evaluating concrete dam operation performance, and the storage medium provided by the embodiments of the present application, a logic architecture of quantitative derivation of the concrete dam operation performance mainly has two aspects, a longitudinal dimension and a transverse dimension. The longitudinal dimension is the principal line of assessing longitudinal evaluation of the on-line evaluation layered model, and an analysis idea of the concrete dam from local to global and from details to whole is objectively reflected from six levels of monitoring data, diagnosis methods, monitored items, evaluation indicators, key parts and an overall project. The transverse dimension is an element set for evaluating the concrete dam operation performance, comparison of importance degrees of various assessment elements at the same level is conducted, and at the same time, an association relationship between the elements at the same level is established. Therefore, by means of operation performance evaluation in the longitudinal dimension and the transverse dimension, rapid and intelligent assessment of the concrete dam operation performance is achieved, and safety evaluation of the concrete dam operation performance is more systematic, comprehensive, accurate and reliable.

Additional aspects and advantages of the present application will be partially set forth in the description which follows, and a part will be obvious from the following description, or may be learned by practice of the present application.

### BRIEF DESCRIPTION OF THE DRAWINGS

The above and/or additional aspects and advantages of the present application will become apparent and understandable from the following description of the embodiments in conjunction with the accompanying drawings, wherein:

FIG. 1 is a schematic flow diagram of a method for quantitative derivation of an on-line evaluation layered model for evaluating concrete dam operation performance provided by an embodiment of the present application.

FIG. 2 is a schematic diagram of an on-line evaluation layered model for evaluating concrete dam operation performance provided by an embodiment of the present application.

FIG. 3 is a schematic flow diagram of another method for quantitative derivation of an on-line evaluation layered model for evaluating concrete dam operation performance provided by an embodiment of the present application.

FIG. 4 is an overview of a path from a special working condition to a diagnosis method sub-item provided by an embodiment of the present application.

FIG. 5 is an implementation example diagram of a method for quantitative derivation of an on-line evaluation layered model for evaluating concrete dam operation performance provided by an embodiment of the present application.

FIG. 6 is a schematic structural diagram of an apparatus for quantitative derivation of an on-line evaluation layered model for evaluating concrete dam operation performance provided by an embodiment of the present application.

FIG. 7 is a schematic structural diagram of a system for quantitative derivation of an on-line evaluation layered model for evaluating concrete dam operation performance provided by an embodiment of the present application.

### DETAILED DESCRIPTION

The embodiments of the present application are described in detail below, and examples of the embodiments are shown in the accompanying drawings, where the same or similar reference numerals represent the same or similar elements or elements with the same or similar functions throughout. The embodiments described below with reference to the accompanying drawings are exemplary and are intended to explain the present application, instead of being construed as limiting the present application.

It is to be noted that, the acquisition, storage, use, processing, etc. of data in the technical solution of the present application comply with relevant stipulations in national laws and regulations.

A method and apparatus for quantitative derivation of an on-line evaluation layered model for evaluating concrete dam operation performance in an embodiment of the present application are described below with reference to the accompanying drawings.

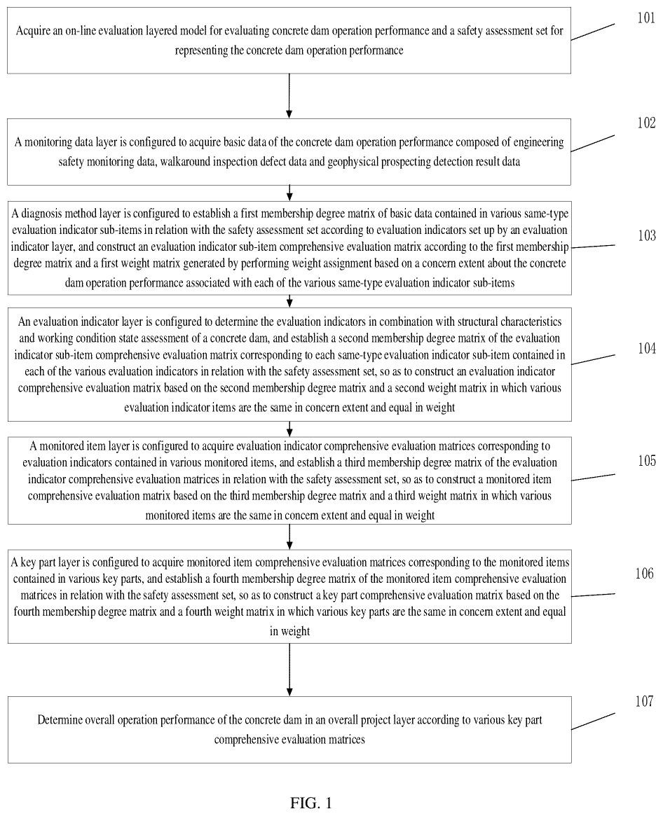

FIG. 1 is a schematic flow diagram of a method for quantitative derivation of an on-line evaluation layered model for evaluating concrete dam operation performance provided by an embodiment of the present application. The on-line evaluation layered model for evaluating concrete dam operation performance includes a monitoring data layer, a diagnosis method layer, an evaluation indicator layer, a monitored item layer, a key part layer and an overall project layer.

As shown in FIG. 1, the overall project layer is a target of on-line evaluation of the concrete dam operation performance, and is used to comprehensively assess overall concrete dam operation performance.

As shown in FIG. 1, the key part layer is a focused object of on-line evaluation of the concrete dam operation performance, and key parts are determined according to computational analysis in a concrete dam design phase or clustering analysis for long-term operation monitoring data, wherein the key part layer is used to analyze assessment results of special items of deformation, seepage, stress-strain and temperature monitoring effect values derived by the monitored item layer, and the key parts are mainly distributed in an upper dam body, a middle dam body, a riverbed dam segment heel, a riverbed dam segment toe and a dam foundation of a concrete dam as well as distribution part regions of defects of long-term concern in project operation.

As shown in FIG. 1, the monitored item layer is an association medium of on-line evaluation of the concrete dam operation performance, and according to standards related to concrete dam design and safety monitoring, the special items of deformation, seepage, stress-strain and temperature monitoring effect values are comprehensively analyzed.

As shown in FIG. 1, the evaluation indicator layer is a process center of on-line evaluation of the concrete dam operation performance, and four types of evaluation indicators of deformation, seepage, stress-strain and temperature are respectively set corresponding to the deformation, seepage, stress-strain and temperature monitoring effect values of concrete dam operation safety in the monitored item layer, wherein under the various types of evaluation indicators, two indicator determining methods are further included: one is determining same-type multi-measuring-point combined calculation evaluation indicators for structural characteristics, and the other is determining data-driven multi-type multi-measuring-point zoned comprehensive evaluation indicators.

Optionally, the same-type multi-measuring-point combined calculation evaluation indicators under deformation evaluation indicators are subdivided into dam foundation deformation vertical distribution, overall horizontal displacement of a dam body, a horizontal displacement coordination degree of the dam body, an overall deflection of a dam segment, overall settlement of the dam body, inter-layer micro deformation of the dam body, an overall opening degree of a foundation surface, an overall opening degree of a structural joint and the like. Besides, there are multi-type multi-measuring-point data comprehensive evaluation indicators for zoned monitoring of deformation.

Optionally, the same-type multi-measuring-point combined calculation evaluation indicators under seepage evaluation indicators are subdivided into overall uplift pressure reduction of the dam foundation, overall anti-sliding stability of the dam foundation, a structural joint osmotic pressure gradient of the dam foundation, a key area seepage amplitude, zoned monitoring of seepage and the like. Besides, there are multi-type multi-measuring-point data comprehensive evaluation indicators for zoned monitoring of seepage.

Optionally, the same-type multi-measuring-point combined calculation evaluation indicators under stress-strain evaluation indicators are subdivided into dam foundation stress vertical distribution, an overall horizontal stress of the dam body, a vertical beam-direction overall stress, a special part strain measuring point amplitude and the like. Besides, there are multi-type multi-measuring-point data comprehensive evaluation indicators for zoned monitoring of stress-strain.

As shown in FIG. 1, the diagnosis method layer is an analysis core of on-line evaluation of the concrete dam operation performance, and on the basis of periodic effects of reservoir water and temperature loads in an operation period of the concrete dam and structural and material changes inside the concrete dam, same-type multi-point or multi-type multi-point monitoring effect value analysis is performed according to the same-type multi-measuring-point combined calculation evaluation indicators and the multi-type multi-measuring-point zoned comprehensive evaluation indicators.

Optionally, for the evaluation indicators under the monitored item of deformation, diagnosis methods for the dam foundation deformation vertical distribution, the overall horizontal displacement of the dam body, the horizontal displacement coordination degree of the dam body, the overall deflection of the dam segment, the overall settlement of the dam body, the inter-layer micro deformation of the dam body, the overall opening degree of the foundation surface, the overall opening degree of the structural joint, zoned monitoring of deformation and the like are proposed. For the evaluation indicators under the monitored item of seepage, diagnosis methods for the overall uplift pressure reduction of the dam foundation, the overall anti-sliding stability of the dam foundation, the structural joint osmotic pressure gradient, the key area seepage amplitude, zoned monitoring of seepage and the like are proposed. For the evaluation indicators under the monitored item of stress-strain, diagnosis methods for the dam foundation stress vertical distribution, the overall horizontal stress of the dam body, the vertical beam-direction overall stress, the special part strain measuring point amplitude, zoned monitoring of the stress-strain and the like are proposed. For the evaluation indicators under the monitored item of the temperature, diagnosis methods for dam foundation temperature changes, the dam body temperature gradient and the like are specifically included.

As shown in FIG. 1, the monitoring data layer is an information base of on-line evaluation of the concrete dam operation performance, and includes engineering safety monitoring data, walkaround inspection defect data and geophysical prospecting detection result data.

Optionally, basic data include engineering safety monitoring data, walkaround inspection defect data and geophysical prospecting detection result data. The engineering safety monitoring data mainly include monitoring data of various types of measuring points for deformation, seepage, stress-strain and the like, such as direct and inverted plumb lines, a multi-point displacement meter, a hydrostatic level displacement meter, a one-way or two-way joint meter, an osmometer, a piezometer tube, a measuring weir, a one-way strain gauge, a multi-directional strain gauge group, an anchor rod stress gauge, and a steel rebar meter. The walkaround inspection defect data mainly include defect data with potential risks and a further development trend, such as cracks, joint misalignment, water seepage, and calcified precipitates discovered on a dam crest or upstream and downstream dam surfaces and galleries in the dam, as well as cavitation and erosion of flow holes in the dam body. The geophysical prospecting detection result data mainly include result data with potential risks and requiring continuous attention discovered through various technical checking or measuring means such as sound waves, images, lasers, and electromagnetic waves.

FIG. 1 is a schematic flow diagram of a method for quantitative derivation of an on-line evaluation layered model for evaluating concrete dam operation performance provided by an embodiment of the present application.

As shown in FIG. 1, the method includes the following steps:
step 101, the on-line evaluation layered model for evaluating concrete dam operation performance and a safety assessment set for representing the concrete dam operation performance are acquired.

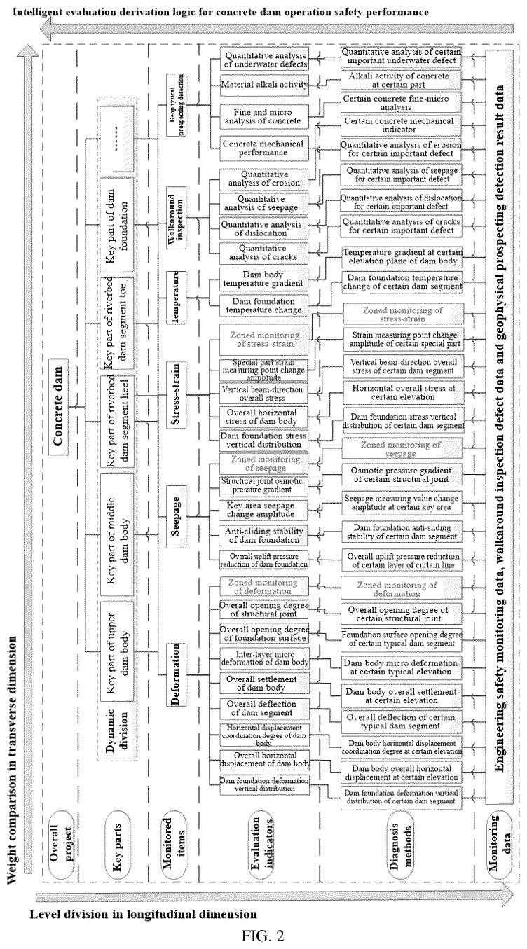

In some embodiments, FIG. 2 is a schematic diagram of the on-line evaluation layered model for evaluating concrete dam operation performance provided by an embodiment of the present application. As shown in FIG. 2, the on-line evaluation layered model for evaluating concrete dam operation performance includes a monitoring data layer, a diagnosis method layer, an evaluation indicator layer, a monitored item layer, a key part layer and an overall project layer.

As shown in FIG. 2, the overall project layer is a target of on-line evaluation of the concrete dam operation performance, and is used to comprehensively assess overall concrete dam operation performance.

As shown in FIG. 2, the key part layer is a focused object of on-line evaluation of the concrete dam operation performance, and key parts may be determined according to computational analysis in a concrete dam design phase or clustering analysis for long-term operation monitoring data, wherein the key part layer is used to analyze assessment results of special items of deformation, seepage, stress-strain and temperature monitoring effect values derived by the monitored item layer, and the key parts are mainly distributed in an upper dam body, a middle dam body, a riverbed dam segment heel, a riverbed dam segment toe and a dam foundation of a concrete dam as well as distribution part regions of defects of long-term concern in project operation.

As shown in FIG. 2, the monitored item layer is an association medium of on-line evaluation of the concrete dam operation performance, and according to standards related to concrete dam design and safety monitoring, the special items of deformation, seepage, stress-strain and temperature monitoring effect values are comprehensively analyzed.

As shown in FIG. 2, the evaluation indicator layer is a process center of on-line evaluation of the concrete dam operation performance, and four types of evaluation indicators of deformation, seepage, stress-strain and temperature are respectively set corresponding to the deformation, seepage, stress-strain and temperature monitoring effect values of concrete dam operation safety in the monitored item layer, wherein under the various types of evaluation indicators, two indicator determining methods are further included: one is determining same-type multi-measuring-point combined calculation evaluation indicators for structural characteristics, and the other is determining data-driven multi-type multi-measuring-point zoned comprehensive evaluation indicators.

Optionally, the same-type multi-measuring-point combined calculation evaluation indicators under deformation evaluation indicators are subdivided into dam foundation deformation vertical distribution, overall horizontal displacement of a dam body, a horizontal displacement coordination degree of the dam body, an overall deflection of a dam segment, overall settlement of the dam body, inter-layer micro deformation of the dam body, an overall opening degree of a foundation surface, an overall opening degree of a structural joint and the like. Besides, there are multi-type multi-measuring-point data comprehensive evaluation indicators for zoned monitoring of deformation.

Optionally, the same-type multi-measuring-point combined calculation evaluation indicators under seepage evaluation indicators are subdivided into overall uplift pressure reduction of the dam foundation, overall anti-sliding stability of the dam foundation, a structural joint osmotic pressure gradient of the dam foundation, a key area seepage amplitude, zoned monitoring of seepage and the like. Besides, there are multi-type multi-measuring-point data comprehensive evaluation indicators for zoned monitoring of seepage.

Optionally, the same-type multi-measuring-point combined calculation evaluation indicators under stress-strain evaluation indicators are subdivided into dam foundation stress vertical distribution, an overall horizontal stress of the dam body, a vertical beam-direction overall stress, a special part strain measuring point amplitude and the like. Besides, there are multi-type multi-measuring-point data comprehensive evaluation indicators for zoned monitoring of stress-strain.

As shown in FIG. 2, the diagnosis method layer is an analysis core of on-line evaluation of the concrete dam operation performance, and on the basis of periodic effects of reservoir water and temperature loads in an operation period of the concrete dam and structural and material changes inside the concrete dam, same-type multi-point or multi-type multi-point monitoring effect value analysis is performed according to the same-type multi-measuring-point combined calculation evaluation indicators and the multi-type multi-measuring-point zoned comprehensive evaluation indicators.

Optionally, for the evaluation indicators under the monitored item of deformation, diagnosis methods for the dam foundation deformation vertical distribution, the overall horizontal displacement of the dam body, the horizontal displacement coordination degree of the dam body, the overall deflection of the dam segment, the overall settlement of the dam body, the inter-layer micro deformation of the dam body, the overall opening degree of the foundation surface, the overall opening degree of the structural joint, zoned monitoring of deformation and the like are proposed. For the evaluation indicators under the monitored item of seepage, diagnosis methods for the overall uplift pressure reduction of the dam foundation, the overall anti-sliding stability of the dam foundation, the structural joint osmotic pressure gradient, the key area seepage amplitude, zoned monitoring of seepage and the like are proposed. For the evaluation indicators under the monitored item of stress-strain, diagnosis methods for the dam foundation stress vertical distribution, the overall horizontal stress of the dam body, the vertical beam-direction overall stress, the special part strain measuring point amplitude, zoned monitoring of the stress-strain and the like are proposed. For the evaluation indicators under the monitored item of the temperature, diagnosis methods for dam foundation temperature changes, the dam body temperature gradient and the like are specifically included.

As shown in FIG. 2, the monitoring data layer is an information base of on-line evaluation of the concrete dam operation performance, and includes engineering safety monitoring data, walkaround inspection defect data and geophysical prospecting detection result data.

Optionally, basic data include engineering safety monitoring data, walkaround inspection defect data and geophysical prospecting detection result data. The engineering safety monitoring data mainly include monitoring data of various types of measuring points for deformation, seepage, stress-strain and the like, such as direct and inverted plumb lines, a multi-point displacement meter, a hydrostatic level displacement meter, a one-way or two-way joint meter, an osmometer, a piezometer tube, a measuring weir, a one-way strain gauge, a multi-directional strain gauge group, an anchor rod stress gauge, and a steel rebar meter. The walkaround inspection defect data mainly include defect data with potential risks and a further development trend, such as cracks, joint misalignment, water seepage, and calcified precipitates discovered on a dam crest or upstream and downstream dam surfaces and galleries in the dam, as well as cavitation and erosion of flow holes in the dam body. The geophysical prospecting detection result data mainly include result data with potential risks and requiring continuous attention discovered through various technical checking or measuring means such as sound waves, images, lasers, and electromagnetic waves.

In other embodiments, the safety assessment set for representing the concrete dam operation performance is determined based on currently-effective standards for concrete dam safety management and assessment sets divided for multiple fields, wherein the safety assessment set is divided into four grades, including normal, basically normal, slightly abnormal and abnormal. It is to be noted here that: the safety assessment set is graded according to the impact of risk events on the operation safety of the dam; and if there is a risk event such as a strong earthquake or a catastrophic flood, the dam body and dam foundation of the dam are susceptible to external special load impacts caused by the risk event, and the dam is prone to various defects and damages. The degree and quantity of the defects directly affect whether the dam can function and operate effectively. Therefore, the safety assessment set divides the grades of whether the dam can function and operate effectively under defect and damage conditions into the four grades: normal, basically normal, slightly abnormal, and abnormal.

“Abnormal” indicates that the dam is unable to function or operate effectively; “slightly abnormal” indicates that the dam is able to function to a limited extent and operate under a low load condition; “basically normal” indicates that the dam is able to function normally within a short period of time and operate under a normal load condition; and “normal” indicates that the dam is able to function normally, operate under a normal load condition, and even operate under a verification working condition.

Optionally, the safety assessment set is defined and described in combination with a human health standard assessment set, a student exam performance assessment set, and currently-effective standards for concrete dam safety management, but not limited to these.

Specifically, regarding the human health standard assessment set: currently, diagnosis of a person's health status is generally divided into four cases: “healthy”, “basically healthy”, “not quite healthy”, and “poor health status”. Therefore, the standard assessment set Va divided for human health is divided into four grades:

$$Va = [ V 1 , V 2 , V 3 , V 4 ] =$$

$$[ healthy , basically healthy , not quite healthy , poor health status ]$$

Regarding the student exam performance assessment set: when school teachers judge the quality of students' exam performance, in addition to specific scores, they generally divide scoring grades into four cases: “excellent”, “good”, “pass”, and “fail”. According to the above viewpoint, the student exam performance assessment set Vb is divided into five grades:

$$Vb = [ V 1 , V 2 , V 3 , V 4 ] = [ excellent , good , pass , fail ]$$

Regarding the currently-effective standards for concrete dam safety management, concrete dam safety grades are divided into A grade normal dams, A− grade normal dams, B grade defective dams, and C grade dangerous dams. According to years of experience in regular operation safety inspections of various types of water conservancy and hydropower dams, except for a few concrete dams identified as defective dams (B grade) or dangerous dams (C grade), the vast majority of concrete dams are normal dams (A or A− grade). In combination with the analysis of the assessment sets of multi-field knowledge such as human health standards, student exam performance, and the currently-effective standards for dam safety management, the division of the safety assessment set for the concrete dam follows the principles of adapting to concrete dam state classification defined by relevant standard specifications, and being compatible with multiple types of objects such as engineering structures and monitored items. With reference to the division idea of the assessment sets of existing knowledge such as the human health standard assessment set, the student exam performance assessment set, and the currently-effective standards for concrete dam safety management, the safety assessment set V_{C} is divided into:

$$Vc = [ VA , VA - , VB , VC ] =$$

$$[ normal , basically normal , slightly abnormal , abnormal ]$$

In addition, assuming that a set of basic data of a concrete dam only contains random errors, which are calculated and processed to obtain a standard deviation, a grading interval is determined according to probability distribution, the probability of values outside (μ−3σ, μ+3σ) is less than 0.3%, which is a low probability event, and therefore, values outside this interval may be considered abnormal, where is a mean value and a is a standard deviation.

Step 102, the monitoring data layer is configured to acquire basic data of the concrete dam operation performance composed of engineering safety monitoring data, walkaround inspection defect data and geophysical prospecting detection result data.

According to the principle of “using up as much as possible”, as much basic data as possible may be pushed to the evaluation indicator layer for calculation. The basic data of various nodes of the monitoring data layer are the same in importance degree and equal in weight.

Step 103, the diagnosis method layer is configured to establish a first membership degree matrix of basic data contained in various same-type evaluation indicator sub-items in relation with the safety assessment set according to the evaluation indicators set up by the evaluation indicator layer, and construct an evaluation indicator sub-item comprehensive evaluation matrix according to the first membership degree matrix and a first weight matrix generated by performing weight assignment based on a concern extent about the concrete dam operation performance associated with each of the various same-type evaluation indicator sub-items.

Optionally, in a case that the evaluation indicators are specifically subdivided into deformation, seepage, stress-strain and temperature, for the evaluation indicators under the monitored item of deformation, they are specifically subdivided into diagnosis methods for the dam foundation deformation vertical distribution, the overall horizontal displacement of the dam body, the horizontal displacement coordination degree of the dam body, the overall deflection of the dam segment, the overall settlement of the dam body, the overall opening degree of the foundation surface, the overall opening degree of the structural joint, zoned monitoring of deformation and the like. For the evaluation indicators under the monitored item of seepage, they are specifically subdivided into diagnosis methods for the overall uplift pressure reduction coefficient of the dam foundation, the structural joint osmotic pressure gradient, the key area seepage amplitude, zoned monitoring of seepage and the like. For the evaluation indicators under the monitored item of stress-strain, they are specifically subdivided into diagnosis methods for the dam foundation stress vertical distribution, the overall horizontal stress of the dam body, the vertical beam-direction overall stress, the special part strain measuring point amplitude, zoned monitoring of the stress-strain and the like. For the evaluation indicators under the monitored item of the temperature, they are specifically subdivided into diagnosis methods for dam foundation temperature changes, the dam body temperature gradient and the like.

In a case that the first membership degree matrix is and the first weight matrix is Wⱼ, the evaluation indicator sub-item comprehensive evaluation matrix may be:

$${U}_{j} = {W}_{j} \cdot {V}_{j} =$$

$$[ \begin{matrix}{w}_{j 1} & {w}_{j 2} & … & {w}_{ji}\end{matrix} ] \cdot [ \begin{matrix}{v}_{j 1 A} & {v}_{{j}_{1 {A}^{-}}} & {v}_{j 1 B} & {v}_{j 1 C} \\ {v}_{j 2 A} & {v}_{j 2 {A}^{-}} & {v}_{j 2 B} & {v}_{j 2 C} \\ … & … & … & … \\ {V}_{jiA} & {V}_{{j}_{{iA}^{-}}} & {V}_{jiB} & {V}_{jiC}\end{matrix} ] = [ \begin{matrix}{u}_{jA} & {u}_{{jA}^{-}} & {u}_{jB} & {u}_{jC}\end{matrix} ]$$

where:

$${W}_{j} = [ {w}_{j 1} , {w}_{j 2} , … , {w}_{ji} ] \\ {V}_{j} = [ \begin{matrix}{v}_{j 1 A} & {v}_{j 1 {A}^{-}} & {v}_{j 1 B} & {v}_{j 1 C} \\ {v}_{j 2 A} & {v}_{{j}_{2 {A}^{-}}} & {v}_{j 2 B} & {v}_{j 2 C} \\ … & … & … & … \\ {v}_{jiA} & {v}_{{j}_{{iA}^{-}}} & {v}_{jiB} & {v}_{jiC}\end{matrix} ]$$

In the formula, V_{jiA}, V_{jiA}_{^{−}}, V_{jiB} and V_{jiC} are calculated result values of concrete dam operation safety assessment sets V_{A}, V_{A}_{^{−}}, V_{B} and V_{C} corresponding to an i^{th} same-type evaluation indicator sub-item respectively, and w₁, is a weight value of a concern extent of the i^{th} same-type evaluation indicator sub-item for the concrete dam operation performance.

Step 104, the evaluation indicator layer is configured to determine the evaluation indicators in combination with structural characteristics and working condition state assessment of the concrete dam, and establish a second membership degree matrix of the evaluation indicator sub-item comprehensive evaluation matrix corresponding to each same-type evaluation indicator sub-item contained in each of the various evaluation indicators in relation with the safety assessment set, so as to construct an evaluation indicator comprehensive evaluation matrix based on the second membership degree matrix and a second weight matrix in which various evaluation indicator items are the same in concern extent and equal in weight.

Optionally, four types evaluation indicators such as deformation, seepage, stress-strain and temperature are set, and under the various types of evaluation indicators, two indicator determining methods are further included: one is determining same-type multi-measuring-point combined calculation evaluation indicators for structural characteristics, and the other is determining data-driven multi-type multi-measuring-point zoned comprehensive evaluation indicators.

The same-type multi-measuring-point combined calculation evaluation indicators under deformation evaluation indicators are subdivided into dam foundation deformation vertical distribution, overall horizontal displacement of a dam body, a horizontal displacement coordination degree of the dam body, an overall deflection of a dam segment, overall settlement of the dam body, an overall opening degree of a foundation surface, an overall opening degree of a structural joint and the like. Besides, there are multi-type multi-measuring-point data comprehensive evaluation indicators for zoned monitoring of deformation. The same-type multi-measuring-point combined calculation evaluation indicators under seepage evaluation indicators are subdivided into an overall uplift pressure reduction coefficient of the dam foundation, a structural joint osmotic pressure gradient, a key area seepage amplitude, zoned monitoring of seepage and the like. Besides, there are multi-type multi-measuring-point data comprehensive evaluation indicators for zoned monitoring of seepage. The same-type multi-measuring-point combined calculation evaluation indicators under stress-strain evaluation indicators are subdivided into dam foundation stress vertical distribution, an overall horizontal stress of the dam body, a vertical beam-direction overall stress, a special part strain measuring point amplitude and the like. Besides, there are multi-type multi-measuring-point data comprehensive evaluation indicators for zoned monitoring of stress-strain. There are a different type of evaluation indicator items such as a dam foundation temperature gradient and a dam body temperature gradient.

In a case that the second membership degree matrix is V_{z} and the second weight matrix is W_{z}, the evaluation indicator comprehensive evaluation matrix U_{z} may be:

$${U}_{z} = {W}_{z} \cdot {V}_{z} =$$

$$[ \begin{matrix}{w}_{z 1} & {w}_{z 2} & … & {w}_{zi}\end{matrix} ] \cdot [ \begin{matrix}{v}_{z 1 A} & {v}_{{z}_{1 {A}^{-}}} & {v}_{z 1 B} & {v}_{z 1 C} \\ {v}_{z 2 A} & {v}_{z 2 {A}^{-}} & {v}_{z 2 B} & {v}_{z 2 C} \\ … & … & … & … \\ {V}_{ziA} & {V}_{{z}_{{iA}^{-}}} & {V}_{ziB} & {V}_{ziC}\end{matrix} ] = [ \begin{matrix}{u}_{zA} & {u}_{{zA}^{-}} & {u}_{zB} & {u}_{zC}\end{matrix} ]$$

where,

$${W}_{z} = [ {w}_{z 1} , {w}_{z 2} , … , {w}_{zi} ]$$

$${V}_{z} = [ \begin{matrix}{v}_{z 1 A} & {v}_{{z1A}^{-}} & {v}_{z 1 B} & {v}_{z 1 C} \\ {v}_{z 2 A} & {v}_{{z2A}^{-}} & {v}_{z 2 B} & {v}_{z 2 C} \\ … & … & … & … \\ {v}_{z i A} & {v}_{{ziA}^{-}} & {v}_{z i B} & {v}_{z i C}\end{matrix} ]$$

In the formula, V_{ziA}, V_{ziA}_{^{−}}, V_{ziB} and V_{ziC} are calculated values of safety assessment sets V_{A}, V_{A}⁻, V_{B} and V_{C} corresponding to an i^{th} evaluation indicator respectively, w_{zi} is a weight value of the i^{th} evaluation indicator, where w_{z1}=w_{z2}= . . . =w_{zi}.

Step 105, the monitored item layer is configured to acquire evaluation indicator comprehensive evaluation matrices corresponding to evaluation indicators contained in various monitored items, and establish a third membership degree matrix of the evaluation indicator comprehensive evaluation matrices in relation with the safety assessment set, so as to construct a monitored item comprehensive evaluation matrix based on the third membership degree matrix and a third weight matrix in which various monitored items are the same in concern extent and equal in weight.

In a case that the third membership degree matrix is Vₘ and the third weight matrix is Wₘ, the monitored item comprehensive evaluation matrix Uₘ may be:

$${U}_{m} = {W}_{m} \cdot {V}_{m} = [ \begin{matrix}{w}_{m 1} & {w}_{m 2} & … & {w}_{mi}\end{matrix} ] \cdot [ \begin{matrix}{v}_{m 1 A} & {v}_{{m}_{1 {A}^{-}}} & {v}_{m 1 B} & {v}_{m 1 C} \\ {v}_{m 2 A} & {v}_{{m2A}^{-}} & {v}_{m 2 B} & {v}_{m 2 C} \\ … & … & … & … \\ {V}_{m i A} & {V}_{{m}_{{iA}^{-}}} & {V}_{m i B} & {V}_{m i C}\end{matrix} ] = [ \begin{matrix}{u}_{m A} & {u}_{m {A}^{-}} & {u}_{mB} & {u}_{mC}\end{matrix} ]$$

where,

$${W}_{m} = [ {w}_{m 1} , {w}_{m 2} , … , {w}_{m l} ]$$

$${V}_{m} = [ \begin{matrix}{v}_{m 1 A} & {v}_{m 1 {A}^{-}} & {v}_{m 1 B} & {v}_{m 1 C} \\ {v}_{m 2 A} & {v}_{{m}_{2 {A}^{-}}} & {v}_{m 2 B} & {v}_{m 2 C} \\ … & … & … & … \\ {v}_{m i A} & {v}_{{m}_{{iA}^{-}}} & {v}_{m i B} & {v}_{m i C}\end{matrix} ]$$

In the formula, V_{miA}, V_{miA}_{^{−}}, V_{miB} and V_{miC} are calculated values of safety assessment sets V_{A}, V_{A}_{^{−}}, V_{B} and V_{C} corresponding to an i^{th} monitored item respectively. Wₘᵢ is a weight value of the i^{th} monitored item, where w_{z1}=w_{z2}= . . . =w_{zi}.

Step 106, the key part layer is configured to acquire monitored item comprehensive evaluation matrices corresponding to the monitored items contained in various key parts, and establish a fourth membership degree matrix of the monitored item comprehensive evaluation matrices in relation with the safety assessment set, so as to construct a key part comprehensive evaluation matrix based on the fourth membership degree matrix and a fourth weight matrix in which various key parts are the same in concern extent and equal in weight.

In a case that the fourth membership degree matrix is V_{q} and the fourth weight matrix is W_{q}, the key part comprehensive evaluation matrix U_{q} may be:

$${U}_{q} = {W}_{q} \cdot {V}_{q} = [ \begin{matrix}{w}_{q 1} & {w}_{q 2} & … & {w}_{qi}\end{matrix} ] \cdot [ \begin{matrix}{v}_{q 1 A} & {v}_{q 1 {A}^{-}} & {v}_{q 1 B} & {v}_{q 1 C} \\ {v}_{q 2 A} & {v}_{q 2 {A}^{-}} & {v}_{q 2 B} & {v}_{q 2 C} \\ … & … & … & … \\ {V}_{qiA} & {V}_{{qiA}^{-}} & {v}_{qiB} & {v}_{qiC}\end{matrix} ] = [ \begin{matrix}{u}_{qA} & {u}_{{qA}^{-}} & {u}_{qB} & {u}_{qC}\end{matrix} ]$$

where:

$${W}_{q} = [ {w}_{q 1} , {w}_{q 2} , … , {w}_{qi} ]$$

$${V}_{q} = [ \begin{matrix}{v}_{q 1 A} & {v}_{q 1 {A}^{-}} & {v}_{q 1 B} & {v}_{q 1 C} \\ {v}_{q 2 A} & {v}_{q 2 {A}^{-}} & {v}_{q 2 B} & {v}_{q 2 C} \\ … & … & … & … \\ {V}_{qiA} & {V}_{{qiA}^{-}} & {v}_{qiB} & {v}_{qiC}\end{matrix} ]$$

In the formula, V_{qiA}, V_{qiA}_{^{−}}, V_{qiB} and V_{qiC} are calculated values of safety assessment sets V_{A}, V_{A}_{^{−}}, V_{B} and V_{C} corresponding to an i^{th} key part respectively, w_{qi} is a weight value of the i^{th} key part, where w_{z1}=w_{z2}= . . . w_{zi}.

Step 107, overall operation performance of the concrete dam in the overall project layer is determined according to various key part comprehensive evaluation matrices.

According to the method for quantitative derivation of the on-line evaluation layered model for evaluating concrete dam operation performance in the embodiment of the present application, a logic architecture of quantitative derivation of the concrete dam operation performance mainly has two aspects, a longitudinal dimension and a transverse dimension. The longitudinal dimension is the principal line of assessing longitudinal evaluation of the on-line evaluation layered model, and an analysis idea of the concrete dam from local to global and from details to whole is objectively reflected from six levels of monitoring data, diagnosis methods, monitored items, evaluation indicators, key parts and an overall project. The transverse dimension is an element set for evaluating the concrete dam operation performance, comparison of importance degrees of various assessment elements at the same level is conducted, and at the same time, an association relationship between the elements at the same level is established. Therefore, by means of operation performance evaluation in the longitudinal dimension and the transverse dimension, rapid and intelligent assessment of the concrete dam operation performance is achieved, and safety evaluation of the concrete dam operation performance is more systematic, comprehensive, accurate and reliable.

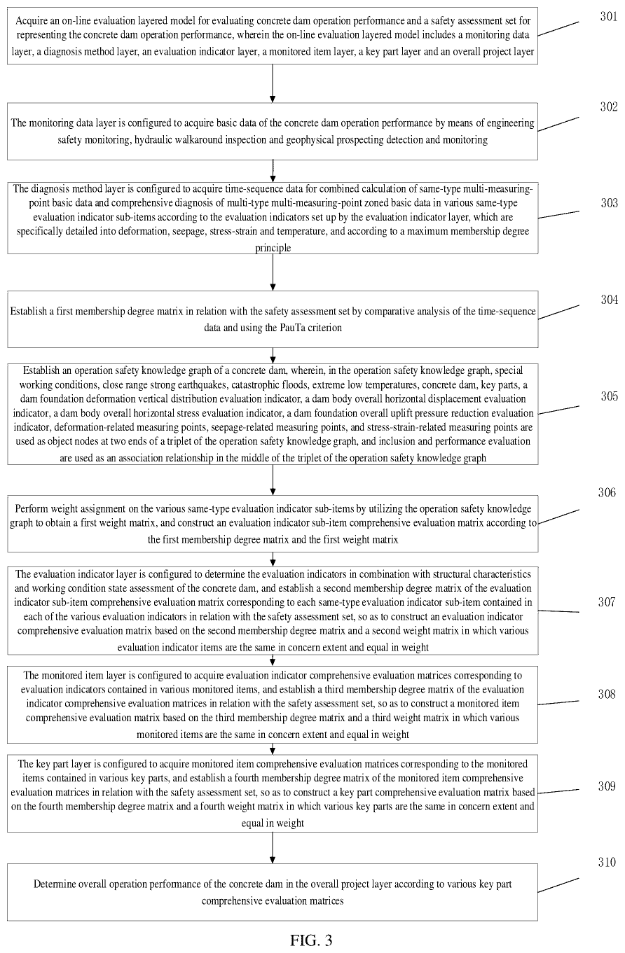

In order to explain the above embodiment clearly, FIG. 3 is a schematic flow diagram of another method for quantitative derivation of an on-line evaluation layered model for evaluating concrete dam operation performance provided by an embodiment of the present application.

Step 301, the on-line evaluation layered model for evaluating concrete dam operation performance and a safety assessment set for representing the concrete dam operation performance are acquired, wherein the on-line evaluation layered model includes a monitoring data layer, a diagnosis method layer, an evaluation indicator layer, a monitored item layer, a key part layer and an overall project layer.

Step 302, the monitoring data layer is configured to acquire basic data of the concrete dam operation performance by means of engineering safety monitoring, hydraulic walkaround inspection and geophysical prospecting detection and monitoring.

It is to be noted that, reference may be made to the description of relevant embodiments of the present application for specific implementations of step 301 to step 302, which is omitted here.

Step 303, the diagnosis method layer is configured to acquire time-sequence data for combined calculation of same-type multi-measuring-point basic data and comprehensive diagnosis of multi-type multi-measuring-point zoned basic data in various same-type evaluation indicator sub-items according to the evaluation indicators set up by the evaluation indicator layer, which are specifically detailed into deformation, seepage, stress-strain and temperature, and according to a maximum membership degree principle.

Optionally, all previous calculation results (data results of combined calculation of the same-type multi-measuring-point basic data and comprehensive diagnosis of the multi-type multi-measuring-point zoned basic data in the various same-type evaluation indicator sub-items) in the diagnosis method layer are quantitatively assessed with correlation coefficients according to the maximum membership degree principle, all previous correlation coefficients form long-sequence data over time, and the time-sequence data accumulated in a long term are generated.

Step 304, a first membership degree matrix in relation with the safety assessment set is established by comparative analysis of the time-sequence data and using the PauTa criterion.

In some embodiments, an implementation of establishing the first membership degree matrix in relation with the safety assessment set by comparative analysis of the time-sequence data and using the PauTa criterion may be performing quantitative assessment on the time-sequence data with the correlation coefficients to acquire the long-sequence data formed by all previous correlation coefficients accumulated overtime; and establishing a correspondence relationship between the long-sequence data and the safety assessment set through the PauTa criterion to be used as the first membership degree matrix.

Specifically, a machine learning based method for adaptive fitting and analysis of the time-sequence data may be used to achieve comparative analysis of the time-sequence data, and automatically select and dynamically match time-sequence data fitting models and their parameters, including the following steps: a time-sequence data adaptive fitting model library; an automatic configuration method for time-sequence data analysis models and parameters; and an adaptive fitting and analysis step for the time-sequence data.

Optionally, in the time-sequence data adaptive fitting model library, 9 models, such as polynomial fitting, mean fitting, least squares fitting, a multilayer perceptron, an LSTM, an attention mechanism-based LSTM, a random forest, a differential autoregressive moving average model, and a GCN graph convolutional neural network, are used to construct the time-sequence data adaptive fitting model library. The polynomial fitting is a simple curve fitting algorithm. The mean fitting refers to finding a mean value of data, which is used for time-sequence data with small amplitudes. The least squares fitting finds an optimal function match for data by minimizing a sum of squared errors. The multilayer perceptron, the LSTM, and the attention mechanism-based LSTM are all neural network models that analyze large amounts of data to obtain more precise predicted values, especially prominent on time-sequence data. The differential autoregressive moving average model is a commonly used statistical model for time-sequence prediction. The GCN graph convolutional neural network aims to extend convolution to the graph field and effectively extract spatial-temporal features for prediction. The multiple types of models are integrated into the model library, providing support for precise fitting of long-term accumulated correlation coefficient time-sequence data.

Optionally, the automatic configuration method for the time-sequence data analysis models and the parameters includes: on the basis of constructing the time-sequence data adaptive fitting model library, model optimization and parameter training are performed on the time-sequence data formed by historical comparative correlation coefficient rₜ of the various same-type evaluation indicator sub-items. To prevent overfitting during model training, no exception handling is performed and missing data are not considered. Model optimization and parameter training use models in the long-sequence data adaptive fitting model library, and evaluate model fitting precision using an R-squared value. A hyper-parameter set of a model is a vector, containing all parameters that the model needs to be trained on, and the number of elements in different model vectors varies. Taking the LSTM as an example, it is necessary to set a hyper-parameter set that contains the number of input layer neurons, the number of hidden layer neurons, loss function names, optimizer names, the number of iterations, batch sizes, validation set sizes, etc.

An automatic matching method for models is specifically as follows:
parameters are configured for each model, an R-squared value of each model is calculated, and the model with the highest R-squared value is selected to be configured to the corresponding same-type evaluation indicator sub-item.

The number and value range of the parameters of each model are preset and divided into two cases: no parameter and with parameters. The parameters are not trained in the case of no parameter. In the case of with parameters, G1 hyper-parameter value sets are randomly generated first, and input along with the acquired long-sequence data into the model for training to obtain G1 R-squared values, the G1 hyper-parameter value sets (R-squared values) are input into a surrogate model for training, wherein the surrogate model is randomly selected, and afterwards, G2 hyper-parameter value sets are randomly generated and input into the surrogate model to obtain G2 R-squared values. A default value of G1 is 1000 and a default value of G2 is 2000, which are adjusted according to the actual situation. Finally, the parameter with the highest R-squared value is selected from the G1+G2 hyper-parameter value sets as the optimal parameter, and the optimal parameter is configured to the corresponding model.

Sequence data of the correlation coefficients of the diagnosis method sub-item are input into all the models in the model library in sequence. Each model needs to be trained G1+G2 times, and a result of (ŷ₁, ŷ₂, . . . , ŷₙ) is obtained each time and its R-squared value is solved, which is calculated through Formula (1). Parameter values of each model are configured first according to the hyper-parameter set with the highest R-squared value, then the R-squared values of the models are compared, and a model with the highest R-squared value is selected as a correlation coefficient fitting model of the diagnosis method sub-item.

$${R}_{j}^{2} = 1 - \frac{{\sum }_{i = 1}^{m} {( {\hat{y}}_{i} - {y}_{i} )}^{2} / m}{{\sum }_{i = 1}^{m} {( {y}_{i} - \overline{y} )}^{2} / m} \qquad ( 1 )$$

In the formula, j denotes an n^{th} matched model, j=1, 2, . . . , n, ŷᵢ is an i^{th} predicted value, y̅ is a mean value, and a model with the highest value of Rⱼ² is configured to the same-time evaluation indicator sub-item.

A representative diagnosis method sub-item (same-type evaluation indicator sub-item) is selected to be configured with models and their parameters, then 5 diagnosis method sub-items which are randomly selected are traversed in sequence to acquire top n times of data (tᵢ₁, . . . , tᵢₙ) of the diagnosis method sub-item Tᵢ, and a data similarity is calculated with all diagnosis method sub-items Tⱼ which are well-configured, wherein the similarity is calculated using a method of a morphological similarity distance in Formula 2:

$${D}_{M S D} ( {T}_{i} , {T}_{j} ) = \sqrt{{\sum }_{k = 1}^{n} ( {t}_{ik} - {t}_{jk} )} \times [ 2 - \frac{\vert {\sum }_{k = 1}^{n} ( {t}_{ik} - {t}_{jk} ) \vert}{{\sum }_{k = 1}^{n} \vert {t}_{ik} - {t}_{jk} \vert} ] \qquad ( 2 )$$

In the formula, tᵢₖ is a correlation coefficient of the diagnosis method sub-item Tᵢ in day k, tⱼₖ is a correlation coefficient of the diagnosis method sub-item Tⱼ in day k, a Euclidean distance is calculated through

$$\sqrt{{\sum }_{k = 1}^{n} ( {t}_{ik} - {t}_{jk} )} ,$$

a Manhattan distance is calculated through

$${\sum }_{k = 1}^{n} \vert {t}_{i k} - {t}_{jk} \vert ,$$

and an absolute value of a sum of difference values of the correlation coefficients in the current day is calculated through

$$\vert {\sum }_{k = 1}^{𝔫} ( {t}_{ik} - {t}_{j k} ) \vert .$$

The diagnosis method sub-item with the smallest value of D_{MSD} is used as a similar diagnosis method sub-item, and when D_{MSD}≤S, the same prediction model is directly configured to the diagnosis method sub-item and the similar diagnosis method sub-item, otherwise, an optimal model is re-matched.

The prediction model is updated every other month, an R-squared value of the correlation coefficient of the diagnosis method sub-item in the current month is calculated, and is compared with an R-squared value at an initial configuration phase of the model, and if it is greater than or equal to the R-squared value in the initial configuration phase, the configured model is not changed. If it is smaller than the initial R-squared value and a difference value therebetween is within a range of 0.02, a value range of each parameter Vi in the original hyper-parameter set (v₁, v₂, . . . , vₙ) is reset to [0.5vᵢ, 1.5vᵢ] then values are randomly selected therefrom to generate G hyper-parameter value sets which are input together with correlation data sequence values into the original prediction model to compare R-squared values, and a hyper-parameter set with the highest R-squared value is selected to update the parameters of the original prediction model. Otherwise, a model is re-matched according to the above method, and if an updated prediction model is still the original model, it is necessary to consider adding new models into the model library.

Optionally, the adaptive fitting and analysis step for the time-sequence data includes an off-line phase and an on-line phase. Specifically, at the off-line phase, model matching and parameter training are preferred, and adaptation of an optimal fitting model and its parameters is performed on a long sequence rₜ obtained after comparison of result values of the various diagnosis method sub-items (same-type evaluation indicator sub-items); and at the on-line phase, data fitting calculation and assessment are conducted, and data fitting calculation evaluation and regular assessment of different temporal delays, as well as regular model applicability checking and re-adaptation are mainly carried out.

At the off-line phase, first, for result values of the various diagnosis method sub-items, rₜ of 2 diagnosis method sub-items is randomly selected to form a test set, an optimal fitting model and its parameters are debugged and configured by adopting a model self-matching method, after model and parameter matching is completed through the test set, the diagnosis method sub-items are traversed in sequence to calculate rₜ, morphological similarity assessment is performed on process lines of rₜ of the remaining diagnosis method sub-items and the test set respectively, if similarity assessment conditions are met, the model and parameters of the test set are adopted, and if the similarity assessment conditions are not met, model matching is performed separately.

After model and parameter matching is completed for the various diagnosis method sub-items, data fitting calculation and assessment steps in the on-line phase are started, wherein rₜ of the various diagnosis method sub-items is selected to perform data fitting calculation, a result is compared with a calculated value of rₜ in the current day, and based on this, a change situation of the diagnosis method sub-items in the current period is analyzed preliminarily. When set time for updating the model is reached, precision estimation is performed on the model, the model meeting a set condition for precision is not changed, otherwise, re-matching is conducted.

Step 305, an operation safety knowledge graph of the concrete dam is established, wherein, in the operation safety knowledge graph, special working conditions, close range strong earthquakes, catastrophic floods, extreme low temperatures, concrete dam, key parts, a dam foundation deformation vertical distribution evaluation indicator, a dam body overall horizontal displacement evaluation indicator, a dam body overall horizontal stress evaluation indicator, a dam foundation overall uplift pressure reduction evaluation indicator, deformation-related measuring points, seepage-related measuring points, and stress-strain-related measuring points are used as object nodes at two ends of a triplet of the operation safety knowledge graph, and inclusion and performance evaluation are used as an association relationship in the middle of the triplet of the operation safety knowledge graph.

In some embodiments, the operation safety knowledge graph of the concrete dam is established by using the special working conditions, the close range strong earthquakes, the catastrophic floods, the extreme low temperatures, the concrete dam, the key parts, the dam foundation deformation vertical distribution evaluation indicator, the dam body overall horizontal displacement evaluation indicator, the dam body overall horizontal stress evaluation indicator, the dam foundation overall uplift pressure reduction evaluation indicator, the deformation-related measuring points, the seepage-related measuring points, and the stress-strain-related measuring points as the object nodes at two ends of the triplet of the operation safety knowledge graph, and using the inclusion and performance evaluation as the association relationship in the middle of the triplet of the operation safety knowledge graph.

Main relation types may be as shown in Table 1.

TABLE 1
Main relation types of operation safety knowledge graph of concrete dam

| Object 1 | Relation | Object 2 or property value |
|---|---|---|
| Special working conditions | Inclusion | Close range strong earthquakes |
| Special working conditions | Inclusion | Catastrophic floods |
| Special working conditions | Inclusion | Extreme low temperatures |
| Dams | Inclusion | Key parts |
| Key parts | Performance | Dam foundation deformation |
| | evaluation | vertical distribution |
| Key parts | Performance | Dam body overall horizontal |
| | evaluation | displacement |
| Key parts | Performance | Dam body horizontal |
| | evaluation | displacement coordination |
| | | degree |
| Key parts | Performance | Overall deflection of dam |
| | evaluation | segments |
| Key parts | Performance | Overall settlement of dam body |
| | evaluation | |
| Key parts | Performance | Dam foundation overall uplift |
| | evaluation | pressure reduction |
| Key parts | Performance | Osmotic pressure gradient of |
| | evaluation | structural joints |
| Key parts | Performance | Key area seepage amplitude |
| | evaluation | |
| Key parts | Performance | Dam foundation stress vertical |
| | evaluation | distribution |
| Key parts | Performance | Dam body overall horizontal |
| | evaluation | stress |
| Key parts | Performance | Vertical beam-direction overall |
| | evaluation | stress |
| Key parts | Performance | Special part strain measuring |
| | evaluation | point amplitude |
| Key parts | Performance | Dam foundation temperature |
| | evaluation | change |
| Key parts | Performance | Dam body temperature gradient |
| | evaluation | |
| Dam foundation deformation | Inclusion | Deformation-related measuring |
| vertical distribution | | points |
| Dam body overall horizontal | Inclusion | Deformation-related measuring |
| displacement | | points |
| Dam body horizontal | Inclusion | Deformation-related measuring |
| displacement coordination | | points |
| degree | | |
| Overall deflection of dam | Inclusion | Deformation-related measuring |
| segments | | points |
| Overall settlement of dam body | Inclusion | Deformation-related measuring |
| | | points |
| Dam foundation overall uplift | Inclusion | Seepage-related measuring |
| pressure reduction | | points |
| Osmotic pressure gradient of | Inclusion | Seepage-related measuring |
| structural joints | | points |
| Key area seepage amplitude | Inclusion | Seepage-related measuring |
| | | points |
| Dam foundation stress vertical | Inclusion | Stress-strain-related measuring |
| distribution | | points |
| Dam body overall horizontal | Inclusion | Stress-strain-related measuring |
| stress | | points |
| Vertical beam-direction overall | Inclusion | Stress-strain-related measuring |
| stress | | points |
| Special part strain measuring | Inclusion | Stress-strain-related measuring |
| point amplitude | | points |
| Dam foundation temperature | Inclusion | Temperature-related measuring |
| change | | points |
| Dam body temperature gradient | Inclusion | Temperature-related measuring |
| | | points |
| . . . | . . . | . . . |

In the present embodiment, user items U={uₜ}ₜ₌₁^{M}, are the special working conditions, target items I={iₜ}ₜ₌₁^{N} are all the diagnosis method sub-items (various same-type evaluation indicator sub-items), M and N refer to the number of the user items and the number of the target items respectively, a triplet relation in the graph constitutes a plurality of paths therebetween, and a schematic diagram of an overview of paths from the special working conditions to the diagnosis method sub-items is established referring to a defined path

$${p}_{k} = [ {e}_{1} {\to }^{{r}_{1}} {e}_{2} {\to }^{{r}_{2}} … {\to }^{{r}_{L - 1}} {e}_{L} ] ,$$

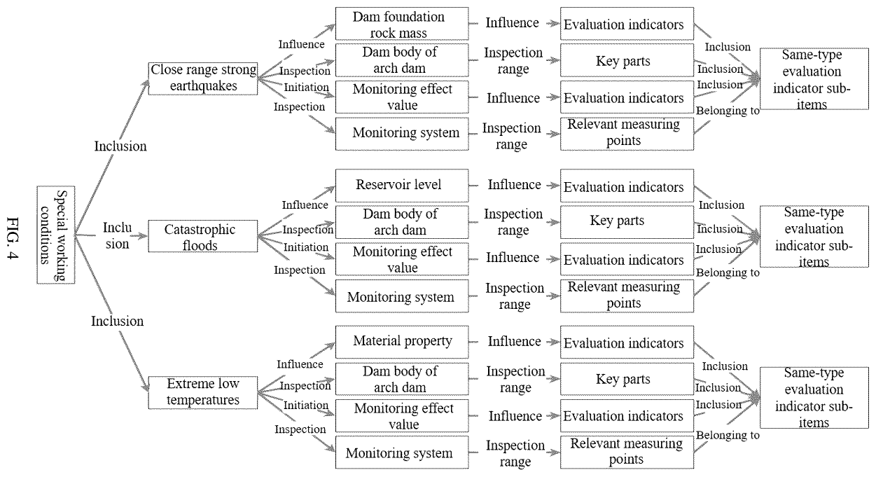

as shown in FIG. 4, eₗ=u, e_{L}=i, (eₗ, rₗ, rₗ₊₁) is an lₜₕ triplet in p, and l denotes the number of triplets in the path.

The plurality of paths from the special working conditions to the diagnosis method sub-items are marked in FIG. 4, and the different paths implies different combined semantic meanings between the special working conditions and the diagnosis method sub-items. The operation safety knowledge graph of the concrete dam is derived by adopting reasoning over knowledge graph paths for recommendation (KPRN), and importance degree scores of the various diagnosis method sub-items under the special working conditions are assessed. The KPRN model uses each user item as an input and outputs a weight score as a score of a concern extent of the user item, namely the special working conditions, for the target item, namely the diagnosis method sub-items, and this model mainly contains a knowledge embedding layer, an LSTM layer and a pooling layer.

Knowledge embedding layer: for a given path pₖ, each entity in the path is encoded into an entity value and an entity type embedding vector, which are denoted as eₗ∈R^{d} and eₗ∈R^{d} respectively, where d is an embedding vector dimension. Relation type embedding rₗ∈R^{d} between entities is introduced additionally to express different semantic information between entity relations. In this model, different relations decide encoding contents of different knowledge sensing paths, which is conducive to deep understanding of the model for an interaction degree between the special working conditions and dam body overall horizontal displacement at a certain typical elevation. Therefore, an encoding layer encodes a path pₖ=[e₁, r₁, e₂, . . . , r_{L-1}, e_{L}].

LSTM layer: three gated neural networks are contained, a forget gate, an input gate and an output gate. In addition, the LSTM further contains a piece of channel information, and only a few number of linear operations are contained, which guarantees invariance of the information in a transmission process. The forget gate decides information discarded in each phase, input information xₜ in this step and an output hₜ₋₁ in the previous step are read, and a value in a range of 0 to 1 is output to decide a ratio of information to be discarded, which is calculated through Formula (3). The input gate decides a proportion of new information added into a current state, which is calculated through Formulas (4) and (5). The output gate decides an output value hₜ based on the current state, which is calculated through Formulas (6) and (7):

$${f}_{t} = σ ( {W}_{f} [ {h}_{t - 1} , {x}_{t} ] + {b}_{f} ) \qquad ( 3 )$$

$${i}_{t} = σ ( {W}_{i} [ {h}_{t - 1} , {x}_{t} ] + {b}_{i} ) \qquad ( 4 )$$

$${\mathring{C}}_{t} = tanh ( {W}_{C} [ {h}_{t - 1} , {x}_{t} ] + {b}_{C} ) \qquad ( 5 )$$

$${o}_{t} = σ ( {W}_{o} [ {h}_{t - 1} , {x}_{t} ] + {b}_{o} ) \qquad ( 6 )$$

$${h}_{t} = {o}_{t}^{*} tanh ( {C}_{t} ) \qquad ( 7 )$$

In the formulas, σ represents a sigmoid function.

In the KPRN model, the LSTM performs a connecting operation on the entity type, the entity value and the relation embedding vector of the knowledge embedding layer as an input vector to obtain a vector h_{L}, replacing all previous input information [e₁, r₁, e₂, . . . , e_{L-1}, r_{L-1}], which is calculated through Formula (8). In order to calculate an interaction score between the special working conditions and the diagnosis method sub-items, two fully-connected layers are adopted to project a final state to a predicted score, which is calculated through Formula (9):

$${x}_{l - 1} = {e}_{l - 1} ⊕ {e}_{l - 1}^{′} ⊕ {r}_{l - 1} \qquad ( 8 )$$

$$s ( τ \vert {p}_{k} ) = {W}_{2}^{T} ReLU ( {W}_{1}^{T} {p}_{k} ) \qquad ( 9 )$$

In the formulas, ⊕ represents a vector splicing operation, and W₁^{T} and W₂^{T} are trainable matrices at a first layer and a second layer respectively.

Pooling layer: a pooling operation is performed according to contributions of the paths for model user item preferences, and all path scores are aggregated, which is calculated through Formula (10). User item-target item scores are predicted finally, which is calculated through Formula (11):

$$g ( {s}_{1} , {s}_{2} , … {s}_{K} ) = log [ {\sum }_{k = 1}^{K} exp ( \frac{{s}_{k}}{γ} ) ] \qquad ( 10 )$$

$${{y}^{\$}}_{u i} = σ ( g ( {s}_{1} , {s}_{2} , … {s}_{K} ) ) \qquad ( 11 )$$

In the formulas, γ is a hyper-parameter controlling each index, and σ represents a sigmoid activation function.

For the user item u, a special working condition, and the target item i∈I, a certain diagnosis method sub-item, I is diagnosis methods included in all the evaluation indicators. Concern extent evaluation is performed on all the diagnosis method sub-items based on the operation safety knowledge graph of the concrete dam to obtain concern extent scores of all the diagnosis method sub-items, which are used as a source of weight calculation. For each diagnosis method sub-item, a sum of own score and scores of all the same-level indicator diagnosis method sub-items is subjected to normalization as a weight value of the diagnosis method sub-item for on-line evaluation of the concrete dam performance, which is calculated through Formula (12):

$${w}_{ui} = \frac{exp ( {{y}^{\$}}_{ui} )}{{\sum }_{i = 1}^{{I}^{′}} exp ( {{y}^{\$}}_{ui} )} \qquad ( 12 )$$

In the formula, wₛᵢ is the weight value of the sub-item, and I′ is a same-type evaluation indicator set to which i belongs.

Step 306, weight assignment is performed on the various same-type evaluation indicator sub-items by utilizing the operation safety knowledge graph to obtain the first weight matrix, and the evaluation indicator sub-item comprehensive evaluation matrix is constructed according to the first membership degree matrix and the first weight matrix.

Optionally, an implementation of performing weight assignment on the concern extent of the various same-type evaluation indicator sub-items for the concrete dam operation performance by utilizing the operation safety knowledge graph to obtain the first weight matrix, and constructing the evaluation indicator sub-item comprehensive evaluation matrix according to the first membership degree matrix and the first weight matrix may be determining various special working conditions of concerned key parts for evaluating the concrete dam operation performance, wherein the special working conditions include close range strong earthquakes, catastrophic floods, and extreme low temperatures; selecting the close range strong earthquakes, the catastrophic floods and the extreme low temperatures as input user items of the operation safety knowledge graph, using the special working conditions to drive the operation safety knowledge graph to activate evaluation indicators that are affected, and calculating weight scores of evaluation indicator sub-items under the various same-type evaluation indicators under the special working conditions, so as to obtain the first weight matrix; and constructing the evaluation indicator sub-item comprehensive evaluation matrix according to the first membership degree matrix and the first weight matrix.

Step 307, the evaluation indicator layer is configured to determine the evaluation indicators in combination with structural characteristics and working condition state assessment of the concrete dam, and establish a second membership degree matrix of the evaluation indicator sub-item comprehensive evaluation matrix corresponding to each same-type evaluation indicator sub-item contained in each of the various evaluation indicators in relation with the safety assessment set, so as to construct an evaluation indicator comprehensive evaluation matrix based on the second membership degree matrix and a second weight matrix in which various evaluation indicator items are the same in concern extent and equal in weight.

Step 308, the monitored item layer is configured to acquire evaluation indicator comprehensive evaluation matrices corresponding to evaluation indicators contained in various monitored items, and establish a third membership degree matrix of the evaluation indicator comprehensive evaluation matrices in relation with the safety assessment set, so as to construct a monitored item comprehensive evaluation matrix based on the third membership degree matrix and a third weight matrix in which various monitored items are the same in concern extent and equal in weight.

Step 309, the key part layer is configured to acquire monitored item comprehensive evaluation matrices corresponding to the monitored items contained in various key parts, and establish a fourth membership degree matrix of the monitored item comprehensive evaluation matrices in relation with the safety assessment set, so as to construct a key part comprehensive evaluation matrix based on the fourth membership degree matrix and a fourth weight matrix in which various key parts are the same in concern extent and equal in weight.

Step 310, overall operation performance of the concrete dam in the overall project layer is determined according to various key part comprehensive evaluation matrices.

In the method for quantitative derivation of the on-line evaluation layered model for evaluating concrete dam operation performance in the embodiment of the present application, a concrete dam operation performance assessment layered architecture is composed of logic layers such as the monitoring data layer, the diagnosis method layer, the evaluation indicator layer, the monitored item layer, the key part layer and the overall project layer. Based on this, the knowledge graph is introduced to perform weight assignment against importance degree differences between the various diagnosis method sub-items so as to establish safety assessment principles of the diagnosis method sub-items and the time-sequence data adaptive analysis model matching with the principles for performing quantitative analysis; and the layered evaluation matrix and a level-by-level derivation mechanism of the concrete dam operation performance assessment layered architecture are proposed, so that rapid and intelligent assessment of the concrete dam operation performance which fuses structural analysis and data driving is achieved.

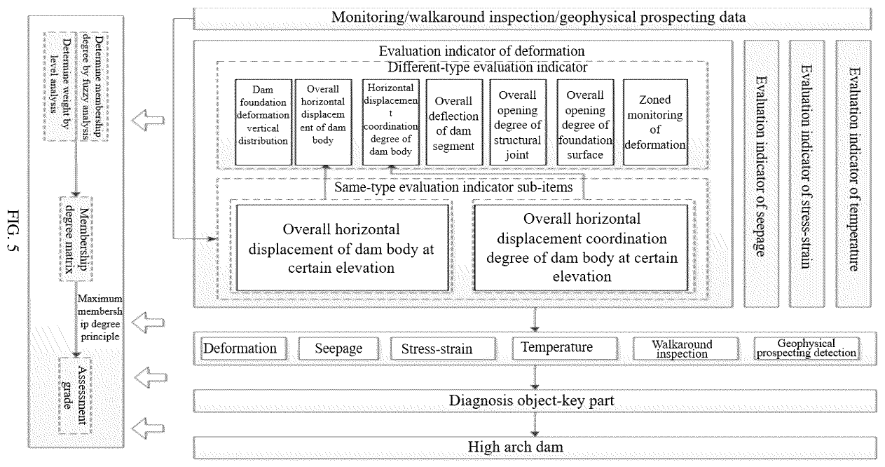

In summary, to better understand the present application, the present application further proposes an implementation example diagram of the method for quantitative derivation of the on-line evaluation layered model for evaluating concrete dam operation performance, as shown in FIG. 5. The monitoring data layer acquires the basic data (monitoring/walkaround inspection/geophysical prospecting data), and the diagnosis method layer establishes the various same-type evaluation indicator sub-items according to the evaluation indicators set up in the evaluation indicator layer, wherein the evaluation indicators include the deformation evaluation indicator, the seepage evaluation indicator, the stress-strain evaluation indicator and the temperature evaluation indicator. The deformation evaluation indicator includes a plurality of different types of evaluation indicators (dam foundation deformation vertical distribution, overall horizontal displacement of a dam body, a horizontal displacement coordination degree of the dam body, an overall deflection of a dam segment, an overall opening degree of a foundation surface, an overall opening degree of a structural joint and zoned monitoring of deformation). The overall horizontal displacement of the dam body includes: overall horizontal displacement of the dam body at a certain elevation. The horizontal displacement coordination degree of the dam body includes: an overall horizontal displacement coordination degree of the dam body at a certain elevation. The evaluation indicator layer determines the evaluation indicators (deformation, seepage, strain and temperature) through concrete dam structural characteristics checked via walkaround inspection and geophysical prospecting and working condition state assessment, acquires various monitored items (diagnosis objects) monitored by the monitored item layer as well as key parts monitored by the key part layer, and finally determines an overall state of the concrete dam (high arch dam) in the overall project layer. In addition, for the monitoring data layer, the diagnosis method layer, the evaluation indicator layer, the monitored item layer, the key part layer and the overall project layer, evaluation indicator sub-item weight value analysis results are applied to derivation in various level analysis, specifically, by utilizing a manner of determining membership degrees through fuzzy analysis and determining evaluation indicator sub-item weight values through level analysis, 1 membership degree matrix can be obtained for elements at the same level of the on-line evaluation layered model, and finally assessment grades (evaluation matrices) of various evaluation levels for the operation performance are obtained according to the maximum membership principle.

In order to implement the above embodiment, the present application further proposes an apparatus for quantitative derivation of an on-line evaluation layered model for evaluating concrete dam operation performance. The on-line evaluation layered model for evaluating concrete dam operation performance includes a monitoring data layer, a diagnosis method layer, an evaluation indicator layer, a monitored item layer, a key part layer and an overall project layer, wherein:
the overall project layer is a target of on-line evaluation of the concrete dam operation performance, and is used to comprehensively assess overall concrete dam operation performance;
the key part layer is a focused object of on-line evaluation of the concrete dam operation performance, and key parts are determined according to computational analysis in a concrete dam design phase or clustering analysis for long-term operation monitoring data, wherein the key part layer is used to analyze assessment results of special items of deformation, seepage, stress-strain and temperature monitoring effect values derived by the monitored item layer, and the key parts are mainly distributed in an upper dam body, a middle dam body, a riverbed dam segment heel, a riverbed dam segment toe and a dam foundation of a concrete dam as well as distribution part regions of defects of long-term concern in project operation;
the monitored item layer is an association medium of on-line evaluation of the concrete dam operation performance, and according to standards related to concrete dam design and safety monitoring, the special items of deformation, seepage, stress-strain and temperature monitoring effect values are comprehensively analyzed;
the evaluation indicator layer is a process center of on-line evaluation of the concrete dam operation performance, and four types of evaluation indicators of deformation, seepage, stress-strain and temperature are respectively set corresponding to the deformation, seepage, stress-strain and temperature monitoring effect values of concrete dam operation safety in the monitored item layer, wherein under the various types of evaluation indicators, two indicator determining methods are further included: one is determining same-type multi-measuring-point combined calculation evaluation indicators for structural characteristics, and the other is determining data-driven multi-type multi-measuring-point zoned comprehensive evaluation indicators;
the diagnosis method layer is an analysis core of on-line evaluation of the concrete dam operation performance, and on the basis of periodic effects of reservoir water and temperature loads in an operation period of the concrete dam and structural and material changes inside the concrete dam, same-type multi-point or multi-type multi-point monitoring effect value analysis is performed according to the same-type multi-measuring-point combined calculation evaluation indicators and the multi-type multi-measuring-point zoned comprehensive evaluation indicators; and
the monitoring data layer is an information base of on-line evaluation of the concrete dam operation performance, and includes engineering safety monitoring data, walkaround inspection defect data and geophysical prospecting detection result data.

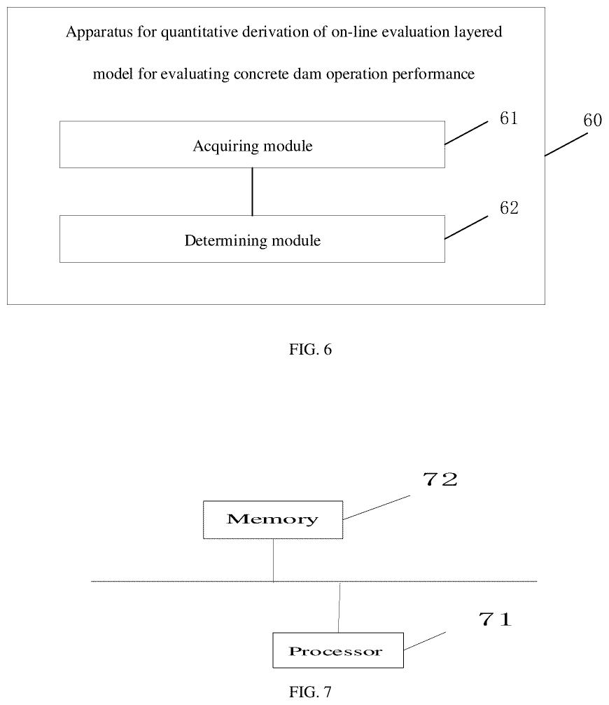

FIG. 6 is a schematic structural diagram of an apparatus for quantitative derivation of an on-line evaluation layered model for evaluating concrete dam operation performance provided by an embodiment of the present application.

As shown in FIG. 6, the apparatus 60 for quantitative derivation of the on-line evaluation layered model for evaluating concrete dam operation performance includes: an acquiring module 61 and a determining module 62.

The acquiring module 61 is configured to acquire the on-line evaluation layered model for evaluating concrete dam operation performance and a safety assessment set for representing the concrete dam operation performance, wherein the on-line evaluation layered model includes a monitoring data layer, a diagnosis method layer, an evaluation indicator layer, a monitored item layer, a key part layer and an overall project layer.

The monitoring data layer is configured to acquire basic data of the concrete dam operation performance by means of engineering safety monitoring, hydraulic walkaround inspection and geophysical prospecting detection and monitoring.

The diagnosis method layer is configured to establish a first membership degree matrix of basic data contained in various same-type evaluation indicator sub-items in relation with the safety assessment set according to the evaluation indicators set up by the evaluation indicator layer, and construct an evaluation indicator sub-item comprehensive evaluation matrix according to the first membership degree matrix and a first weight matrix generated by performing weight assignment based on a concern extent about the concrete dam operation performance associated with each of the various same-type evaluation indicator sub-items.

The evaluation indicator layer is configured to determine the evaluation indicators in combination with structural characteristics and working condition state assessment of the concrete dam, and establish a second membership degree matrix of the evaluation indicator sub-item comprehensive evaluation matrix corresponding to each same-type evaluation indicator sub-item contained in each of the various evaluation indicators in relation with the safety assessment set, so as to construct an evaluation indicator comprehensive evaluation matrix based on the second membership degree matrix and a second weight matrix in which various evaluation indicator items are the same in concern extent and equal in weight.

The monitored item layer is configured to acquire evaluation indicator comprehensive evaluation matrices corresponding to evaluation indicators contained in various monitored items, and establish a third membership degree matrix of the evaluation indicator comprehensive evaluation matrices in relation with the safety assessment set, so as to construct a monitored item comprehensive evaluation matrix based on the third membership degree matrix and a third weight matrix in which various monitored items are the same in concern extent and equal in weight.

The key part layer is configured to acquire monitored item comprehensive evaluation matrices corresponding to the monitored items contained in various key parts, and establish a fourth membership degree matrix of the monitored item comprehensive evaluation matrices in relation with the safety assessment set, so as to construct a key part comprehensive evaluation matrix based on the fourth membership degree matrix and a fourth weight matrix in which various key parts are the same in concern extent and equal in weight.

The determining module 62 is configured to determine overall operation performance of the concrete dam in the overall project layer according to various key part comprehensive evaluation matrices.

Optionally, in a possible implementation of the embodiment of the present application, the safety assessment set for representing the concrete dam operation performance is determined based on currently-effective standards for concrete dam safety management and assessment sets divided for multiple fields, wherein the safety assessment set is divided into four grades, including normal, basically normal, slightly abnormal and abnormal.

Optionally, in a possible implementation of the embodiment of the present application, the diagnosis method layer includes:
an acquiring sub-module, used by the diagnosis method layer to acquire time-sequence data for combined calculation of same-type multi-measuring-point basic data and comprehensive diagnosis of multi-type multi-measuring-point zoned basic data in various same-type evaluation indicator sub-items according to the evaluation indicators set up by the evaluation indicator layer, which are specifically detailed into deformation, seepage, stress-strain and temperature, and according to a maximum membership degree principle;
a first constructing sub-module, configured to establish the first membership degree matrix in relation with the safety assessment set by comparative analysis of the time-sequence data and using the PauTa criterion;
a second constructing sub-module, configured to establish an operation safety knowledge graph of the concrete dam, wherein, in the operation safety knowledge graph, special working conditions, close range strong earthquakes, catastrophic floods, extreme low temperatures, concrete dam, key parts, a dam foundation deformation vertical distribution evaluation indicator, a dam body overall horizontal displacement evaluation indicator, a dam body overall horizontal stress evaluation indicator, a dam foundation overall uplift pressure reduction evaluation indicator, deformation-related measuring points, seepage-related measuring points, and stress-strain-related measuring points are used as object nodes at two ends of a triplet of the operation safety knowledge graph, and inclusion and performance evaluation are used as an association relationship in the middle of the triplet of the operation safety knowledge graph; and
a third constructing sub-module, configured to perform weight assignment on the various same-type evaluation indicator sub-items by utilizing the operation safety knowledge graph to obtain the first weight matrix, and construct the evaluation indicator sub-item comprehensive evaluation matrix according to the first membership degree matrix and the first weight matrix.

Optionally, in a possible implementation of the embodiment of the present application, the first constructing sub-module is specifically configured to:
perform quantitative evaluation on the time-sequence data with a correlation coefficient, to acquire long-sequence data formed by all previous correlation coefficients accumulated over time; and
establish a correspondence relationship between the long-sequence data and the safety assessment set through the PauTa criterion to be used as the first membership degree matrix.

Optionally, in a possible implementation of the embodiment of the present application, the third constructing sub-module is specifically configured to:
determine various special working conditions of concerned key parts for evaluating the concrete dam operation performance, wherein the special working conditions include close range strong earthquakes, catastrophic floods, and extreme low temperatures;
select the close range strong earthquakes, the catastrophic floods and the extreme low temperatures as input user items of the operation safety knowledge graph, use the special working conditions to drive the operation safety knowledge graph to activate evaluation indicators that are affected, and calculate weight scores of evaluation indicator sub-items under the various same-type evaluation indicators under the special working conditions, so as to obtain the first weight matrix; and
construct the evaluation indicator sub-item comprehensive evaluation matrix according to the first membership degree matrix and the first weight matrix.

It is to be noted that, the aforementioned explanation of the method embodiment is also applicable to the apparatus in the embodiment, which is omitted here.

According to the apparatus for quantitative derivation of the on-line evaluation layered model for evaluating concrete dam operation performance in the embodiment of the present application, a logic architecture of quantitative derivation of the concrete dam operation performance mainly has two aspects, a longitudinal dimension and a transverse dimension. The longitudinal dimension is the principal line of assessing longitudinal evaluation of the on-line evaluation layered model, and an analysis idea of the concrete dam from local to global and from details to whole is objectively reflected from six levels of monitoring data, diagnosis methods, monitored items, evaluation indicators, key parts and an overall project. The transverse dimension is an element set for evaluating the concrete dam operation performance, comparison of importance degrees of various assessment elements at the same level is conducted, and at the same time, an association relationship between the elements at the same level is established. Therefore, by means of operation performance evaluation in the longitudinal dimension and the transverse dimension, rapid and intelligent assessment of the concrete dam operation performance is achieved, and safety evaluation of the concrete dam operation performance is more systematic, comprehensive, accurate and reliable.

In order to implement the above embodiments, the present application further proposes a system for quantitative derivation of an on-line evaluation layered model for evaluating concrete dam operation performance, as shown in FIG. 7, including:
at least one processor 71; and
a memory 72 in communication connection with the at least one processor 71; wherein
the memory 72 has instructions stored therein that can be executed by the at least one processor 71, and the instructions, when executed by the at least one processor 71, causes the at least one processor 71 to be capable of executing the aforementioned method.

In order to implement the above embodiments, the present application further proposes a non-transitory computer-readable storage medium having computer instructions stored therein, wherein the computer instructions are configured to cause a computer to execute the aforementioned method.

In the description of the specification, descriptions with reference to the terms “one embodiment”, “some embodiments”, “examples”, “specific examples”, or “some examples” means that specific features, structures, materials, or characteristics described in conjunction with the embodiments or examples are included in at least one embodiment or example of the present application. In the specification, the schematic expressions of the above terms do not necessarily refer to the same embodiments or examples. Moreover, the specific features, structures, materials, or characteristics described may be combined in any one or more embodiments or examples in an appropriate manner. In addition, those skilled in the art may combine the different embodiments or examples described in the specification, as well as the features of the different embodiments or examples, without conflicting with each other.

In addition, the terms “first” and “second” are only for descriptive purposes and cannot be understood as indicating or implying relative importance or implicitly specifying the quantity of technical features indicated. Therefore, features that are defined by “first” and “second” can explicitly or implicitly include at least one of these features. In the description of the present application, the meaning of “a plurality of” is at least two, such as two and three, unless otherwise explicitly and specifically defined.

Any process or method description in a flow diagram or otherwise described herein can be understood as representing a module, fragment, or portion of code including one or more executable instructions for implementing steps of a customized logic function or process, and the scope of optional implementations of the present application includes additional implementations, wherein it is possible to execute functions in a manner that is not in the order shown or discussed, but rather in a manner that is essentially simultaneous or in reverse order based on the functions involved. This should be understood by those skilled in the art to which the embodiments of the present application belong.

The logic and/or steps represented in a flow diagram or otherwise described herein, such as a sequential list of executable instructions used to implement logical functions, can be specifically implemented in any computer-readable medium for use by instruction execution systems, apparatuses, or devices (such as computer-based systems, systems including processors, or other systems that can take instructions from instruction execution systems, apparatuses, or devices and execute the instructions), or used in conjunction with these instruction execution systems, apparatuses, or devices. As for the specification, a “computer-readable medium” may be any apparatus that can contain, store, communicate, disseminate, or transmit programs for use in instruction execution systems, apparatuses, or devices, or in combination with such instruction execution systems, apparatuses, or devices. More specific examples of the computer-readable medium (non-exhaustive list) include the following: an electrical connecting portion (electronic apparatus) with one or more wiring, a portable computer enclosure (magnetic apparatus), a random access memory (RAM), a read-only memory (ROM), an erasable and editable read-only memory (EPROM or flash memory), a fiber optic apparatus, and a portable optical disc read-only memory (CDROM). In addition, the computer-readable medium may even be paper or other suitable media on which programs can be printed, as the programs may be obtained electronically, for example, by optical scanning of paper or other media, followed by editing, interpretation, or necessary processing in other suitable ways, and then stored in a computer memory.

It should be understood that the various parts of the present application may be implemented using hardware, software, firmware, or a combination thereof. In the above implementations, multiple steps or methods may be implemented using software or firmware stored in a memory and executed by a suitable instruction execution system. For example, if implemented by hardware, as in another implementation, any one or a combination of the following techniques known in the art may be used: discrete logic circuits with logic gate circuits for implementing logic functions on data signals, application-specific integrated circuits with suitable combinational logic gate circuits, programmable gate arrays (PGAs), field programmable gate arrays (FPGAs), etc.

Those ordinarily skilled in the art may understand that all or part of the steps carried in the method of the above embodiment may be completed by instructing relevant hardware through programs. The programs may be stored in a computer-readable storage medium, and the programs, when executed, include one or a combination of the steps of the method embodiment.

In addition, functional units in respective embodiments of the present application may be integrated into one processing module, or each of the units may exist alone physically, or two or more units may be integrated into one module. The above integrated module may be implemented in the form of hardware or in the form of software functional modules. If the integrated modules are implemented in the form of software functional modules and are sold or used as independent products, the modules may also be stored in a computer-readable storage medium.

The aforementioned storage medium may be a read-only memory, a magnetic disk or an optical disk. Although the embodiments of the present application have been shown and described above, it can be understood that, the above embodiments are exemplary and should not be construed as limiting the present application. Those of ordinary skills in the art may make changes, modifications, substitutions, and variations to the above embodiments within the scope of the present application.

1. A method for quantitative derivation of an on-line evaluation layered model for evaluating concrete dam operation performance, wherein the on-line evaluation layered model for evaluating the concrete dam operation performance comprises a monitoring data layer, a diagnosis method layer, an evaluation indicator layer, a monitored item layer, a key part layer and an overall project layer, wherein:
the overall project layer is a target of on-line evaluation of the concrete dam operation performance, and is used to comprehensively assess overall concrete dam operation performance;
the key part layer is a focused object of on-line evaluation of the concrete dam operation performance, and key parts are determined according to computational analysis in a concrete dam design phase or clustering analysis for long-term operation monitoring data, wherein the key part layer is used to analyze assessment results of special items of deformation, seepage, stress-strain and temperature monitoring effect values derived by the monitored item layer, and the key parts are mainly distributed in an upper dam body, a middle dam body, a riverbed dam segment heel, a riverbed dam segment toe and a dam foundation of a concrete dam as well as distribution part regions of defects of long-term concern in project operation;
the monitored item layer is an association medium of on-line evaluation of the concrete dam operation performance, and according to standards related to concrete dam design and safety monitoring, the special items of deformation, seepage, stress-strain and temperature monitoring effect values are comprehensively analyzed;
the evaluation indicator layer is a process center of on-line evaluation of the concrete dam operation performance, and four types of evaluation indicators of deformation, seepage, stress-strain and temperature are respectively set corresponding to the deformation, seepage, stress-strain and temperature monitoring effect values of concrete dam operation safety in the monitored item layer, wherein under the various types of evaluation indicators, two indicator determining methods are further included: one is determining same-type multi-measuring-point combined calculation evaluation indicators for structural characteristics, and the other is determining data-driven multi-type multi-measuring-point zoned comprehensive evaluation indicators;
the diagnosis method layer is an analysis core of on-line evaluation of the concrete dam operation performance, and on the basis of periodic effects of reservoir water and temperature loads in an operation period of the concrete dam and structural and material changes inside the concrete dam, same-type multi-point or multi-type multi-point monitoring effect value analysis is performed according to the same-type multi-measuring-point combined calculation evaluation indicators and the multi-type multi-measuring-point zoned comprehensive evaluation indicators; and
the monitoring data layer is an information base of on-line evaluation of the concrete dam operation performance, and comprises engineering safety monitoring data, walkaround inspection defect data and geophysical prospecting detection result data; and
the method further comprises:
acquiring the on-line evaluation layered model for evaluating the concrete dam operation performance and a safety assessment set for representing the concrete dam operation performance; wherein
the monitoring data layer is configured to acquire basic data of the concrete dam operation performance composed of engineering safety monitoring data, walkaround inspection defect data and geophysical prospecting detection result data;
the diagnosis method layer is configured to establish a first membership degree matrix of basic data contained in various same-type evaluation indicator sub-items in relation with the safety assessment set according to the evaluation indicators set up by the evaluation indicator layer, and construct an evaluation indicator sub-item comprehensive evaluation matrix according to the first membership degree matrix and a first weight matrix generated by performing weight assignment based on a concern extent about the concrete dam operation performance associated with each of the various same-type evaluation indicator sub-items;
the evaluation indicator layer is configured to determine the evaluation indicators in combination with structural characteristics and working condition state assessment of the concrete dam, and establish a second membership degree matrix of the evaluation indicator sub-item comprehensive evaluation matrix corresponding to each same-type evaluation indicator sub-item contained in each of the various evaluation indicators in relation with the safety assessment set, so as to construct an evaluation indicator comprehensive evaluation matrix based on the second membership degree matrix and a second weight matrix in which various evaluation indicator items are the same in concern extent and equal in weight;
the monitored item layer is configured to acquire evaluation indicator comprehensive evaluation matrices corresponding to evaluation indicators contained in various monitored items, and establish a third membership degree matrix of the evaluation indicator comprehensive evaluation matrices in relation with the safety assessment set, so as to construct a monitored item comprehensive evaluation matrix based on the third membership degree matrix and a third weight matrix in which various monitored items are the same in concern extent and equal in weight; and
the key part layer is configured to acquire monitored item comprehensive evaluation matrices corresponding to the monitored items contained in various key parts, and establish a fourth membership degree matrix of the monitored item comprehensive evaluation matrices in relation with the safety assessment set, so as to construct a key part comprehensive evaluation matrix based on the fourth membership degree matrix and a fourth weight matrix in which various key parts are the same in concern extent and equal in weight; and
determining overall operation performance of the concrete dam in the overall project layer according to the key part comprehensive evaluation matrix.

2. The method according to claim 1, wherein the safety assessment set for representing the concrete dam operation performance is determined based on currently-effective standards for concrete dam safety management and assessment sets divided for multiple fields, wherein the safety assessment set is divided into four grades, comprising normal, basically normal, slightly abnormal and abnormal; wherein “abnormal” indicates that the dam is unable to function and operate effectively; “slightly abnormal” indicates that the dam is able to function to a limited extent and operate under a low load condition; “basically normal” indicates that the dam is able to function normally within a short period of time and operate under a normal load condition; and “normal” indicates that the dam is able to function normally, operate under a normal load condition, and even operate under a verification working condition.

3. The method according to claim 1, wherein the diagnosis method layer is configured to establish the first membership degree matrix of the basic data contained in the various same-type evaluation indicator sub-items in relation with the safety assessment set according to the evaluation indicators set up by the evaluation indicator layer, and construct the evaluation indicator sub-item comprehensive evaluation matrix according to the first membership degree matrix and the first weight matrix generated by performing weight assignment based on the concern extent about the concrete dam operation performance associated with each of the various same-type evaluation indicator sub-items by executing steps comprising:
the diagnosis method layer being used to acquire time-sequence data for combined calculation of same-type multi-measuring-point basic data and comprehensive diagnosis of multi-type multi-measuring-point zoned basic data in various same-type evaluation indicator sub-items according to the evaluation indicators set up by the evaluation indicator layer, which are specifically detailed into deformation, seepage, stress-strain and temperature, and according to a maximum membership degree principle;
establishing the first membership degree matrix in relation with the safety assessment set by comparative analysis of the time-sequence data and using the PauTa criterion;
establishing an operation safety knowledge graph of the concrete dam, wherein, in the operation safety knowledge graph, special working conditions, close range strong earthquakes, catastrophic floods, extreme low temperatures, concrete dam, key parts, a dam foundation deformation vertical distribution evaluation indicator, a dam body overall horizontal displacement evaluation indicator, a dam body overall horizontal stress evaluation indicator, a dam foundation overall uplift pressure reduction evaluation indicator, deformation-related measuring points, seepage-related measuring points, and stress-strain-related measuring points are used as object nodes at two ends of a triplet of the operation safety knowledge graph, and inclusion and performance evaluation are used as an association relationship in the middle of the triplet of the operation safety knowledge graph; and
performing weight assignment on the various same-type evaluation indicator sub-items by utilizing the operation safety knowledge graph to obtain the first weight matrix, and constructing the evaluation indicator sub-item comprehensive evaluation matrix according to the first membership degree matrix and the first weight matrix.

4. The method according to claim 3, wherein the step of establishing the first membership degree matrix in relation with the safety assessment set by comparative analysis of the time-sequence data and using the PauTa criterion comprises:
performing quantitative evaluation on the time-sequence data with a correlation coefficient, to acquire long-series data formed by all previous correlation coefficients accumulated over time; and
establishing a correspondence relationship between the long-series data and the safety assessment set by using the PauTa criterion, to be used as the first membership degree matrix.

5. The method according to claim 3, wherein the step of performing weight assignment on the various same-type evaluation indicator sub-items by utilizing the operation safety knowledge graph to obtain the first weight matrix, and constructing the evaluation indicator sub-item comprehensive evaluation matrix according to the first membership degree matrix and the first weight matrix comprises:
determining various special working conditions of concerned key parts for evaluating the concrete dam operation performance, wherein the special working conditions comprise close range strong earthquakes, catastrophic floods, and extreme low temperatures;
selecting the close range strong earthquakes, the catastrophic floods and the extreme low temperatures as input user items of the operation safety knowledge graph, using the special working conditions to drive the operation safety knowledge graph to activate evaluation indicators that are affected, and calculating weight scores of evaluation indicator sub-items under the various same-type evaluation indicators under the special working conditions, so as to obtain the first weight matrix; and
constructing the evaluation indicator sub-item comprehensive evaluation matrix according to the first membership degree matrix and the first weight matrix.

6. A non-transitory computer-readable storage medium having computer instructions stored therein, wherein the computer instructions are configured to cause a computer to execute the method according to claim 1.

7. The non-transitory computer-readable storage medium according to claim 6, wherein the safety assessment set for representing concrete dam operation performance is determined based on currently-effective standards for concrete dam safety management and assessment sets divided for multiple fields, wherein the safety assessment set is divided into four grades, comprising normal, basically normal, slightly abnormal and abnormal; wherein “abnormal” indicates that the dam is unable to function and operate effectively; “slightly abnormal” indicates that the dam is able to function to a limited extent and operate under a low load condition; “basically normal” indicates that the dam is able to function normally within a short period of time and operate under a normal load condition; and “normal” indicates that the dam is able to function normally, operate under a normal load condition, and even operate under a verification working condition.

8. The non-transitory computer-readable storage medium according to claim 6, wherein
the diagnosis method layer is configured to establish a first membership degree matrix of basic data contained in various same-type evaluation indicator sub-items in relation with the safety assessment set according to evaluation indicators set up by the evaluation indicator layer, and construct an evaluation indicator sub-item comprehensive evaluation matrix according to the first membership degree matrix and a first weight matrix generated by performing weight assignment based on a concern extent about concrete dam operation performance associated with each of the various same-type evaluation indicator sub-items by executing steps comprising:
the diagnosis method layer being used to acquire time-sequence data for combined calculation of same-type multi-measuring-point basic data and comprehensive diagnosis of multi-type multi-measuring-point zoned basic data in various same-type evaluation indicator sub-items according to the evaluation indicators set up by the evaluation indicator layer, which are specifically detailed into deformation, seepage, stress-strain and temperature, and according to a maximum membership degree principle;
establishing the first membership degree matrix in relation with the safety assessment set by comparative analysis of the time-sequence data and using the PauTa criterion;
establishing an operation safety knowledge graph of the concrete dam, wherein, in the operation safety knowledge graph, special working conditions, close range strong earthquakes, catastrophic floods, extreme low temperatures, concrete dam, key parts, a dam foundation deformation vertical distribution evaluation indicator, a dam body overall horizontal displacement evaluation indicator, a dam body overall horizontal stress evaluation indicator, a dam foundation overall uplift pressure reduction evaluation indicator, deformation-related measuring points, seepage-related measuring points, and stress-strain-related measuring points are used as object nodes at two ends of a triplet of the operation safety knowledge graph, and inclusion and performance evaluation are used as an association relationship in the middle of the triplet of the operation safety knowledge graph; and
performing weight assignment on the various same-type evaluation indicator sub-items by utilizing the operation safety knowledge graph to obtain the first weight matrix, and constructing the evaluation indicator sub-item comprehensive evaluation matrix according to the first membership degree matrix and the first weight matrix.

9. The non-transitory computer-readable storage medium according to claim 8, wherein the step of establishing the first membership degree matrix in relation with the safety assessment set by comparative analysis of the time-sequence data and using the PauTa criterion comprises:
performing quantitative evaluation on the time-sequence data with a correlation coefficient, to acquire long-series data formed by all previous correlation coefficients accumulated over time; and
establishing a correspondence relationship between the long-series data and the safety assessment set by using the PauTa criterion, to be used as the first membership degree matrix.

10. The non-transitory computer-readable storage medium according to claim 8, wherein the step of performing weight assignment on the various same-type evaluation indicator sub-items by utilizing the operation safety knowledge graph to obtain the first weight matrix, and constructing the evaluation indicator sub-item comprehensive evaluation matrix according to the first membership degree matrix and the first weight matrix comprises:
determining various special working conditions of concerned key parts for evaluating the concrete dam operation performance, wherein the special working conditions comprise close range strong earthquakes, catastrophic floods, and extreme low temperatures;
selecting the close range strong earthquakes, the catastrophic floods and the extreme low temperatures as input user items of the operation safety knowledge graph, using the special working conditions to drive the operation safety knowledge graph to activate evaluation indicators that are affected, and calculating weight scores of evaluation indicator sub-items under the various same-type evaluation indicators under the special working conditions, so as to obtain the first weight matrix; and
constructing the evaluation indicator sub-item comprehensive evaluation matrix according to the first membership degree matrix and the first weight matrix.

11. A quantitative derivation system of an on-line evaluation layered model for evaluating concrete dam operation performance, comprising: at least one processor; and a memory in communication connection with the at least one processor; wherein the memory has instructions stored therein that can be executed by the at least one processor, and the instructions, when executed by the at least one processor, causes the at least one processor to execute the method according to claim 1.

12. The derivation system according to claim 11, wherein the safety assessment set for representing concrete dam operation performance is determined based on currently-effective standards for concrete dam safety management and assessment sets divided for multiple fields, wherein the safety assessment set is divided into four grades, comprising normal, basically normal, slightly abnormal and abnormal; wherein “abnormal” indicates that the dam is unable to function and operate effectively; “slightly abnormal” indicates that the dam is able to function to a limited extent and operate under a low load condition; “basically normal” indicates that the dam is able to function normally within a short period of time and operate under a normal load condition; and “normal” indicates that the dam is able to function normally, operate under a normal load condition, and even operate under a verification working condition.

13. The derivation system according to claim 11, wherein
the diagnosis method layer is configured to establish a first membership degree matrix of basic data contained in various same-type evaluation indicator sub-items in relation with the safety assessment set according to evaluation indicators set up by the evaluation indicator layer, and construct an evaluation indicator sub-item comprehensive evaluation matrix according to the first membership degree matrix and a first weight matrix generated by performing weight assignment based on a concern extent about concrete dam operation performance associated with each of the various same-type evaluation indicator sub-items by executing steps comprising:
the diagnosis method layer being used to acquire time-sequence data for combined calculation of same-type multi-measuring-point basic data and comprehensive diagnosis of multi-type multi-measuring-point zoned basic data in various same-type evaluation indicator sub-items according to the evaluation indicators set up by the evaluation indicator layer, which are specifically detailed into deformation, seepage, stress-strain and temperature, and according to a maximum membership degree principle;
establishing the first membership degree matrix in relation with the safety assessment set by comparative analysis of the time-sequence data and using the PauTa criterion;
establishing an operation safety knowledge graph of the concrete dam, wherein, in the operation safety knowledge graph, special working conditions, close range strong earthquakes, catastrophic floods, extreme low temperatures, concrete dam, key parts, a dam foundation deformation vertical distribution evaluation indicator, a dam body overall horizontal displacement evaluation indicator, a dam body overall horizontal stress evaluation indicator, a dam foundation overall uplift pressure reduction evaluation indicator, deformation-related measuring points, seepage-related measuring points, and stress-strain-related measuring points are used as object nodes at two ends of a triplet of the operation safety knowledge graph, and inclusion and performance evaluation are used as an association relationship in the middle of the triplet of the operation safety knowledge graph; and
performing weight assignment on the various same-type evaluation indicator sub-items by utilizing the operation safety knowledge graph to obtain the first weight matrix, and constructing the evaluation indicator sub-item comprehensive evaluation matrix according to the first membership degree matrix and the first weight matrix.

14. The derivation system according to claim 13, wherein the step of establishing the first membership degree matrix in relation with the safety assessment set by comparative analysis of the time-sequence data and using the PauTa criterion comprises:
performing quantitative evaluation on the time-sequence data with a correlation coefficient, to acquire long-series data formed by all previous correlation coefficients accumulated over time; and
establishing a correspondence relationship between the long-series data and the safety assessment set by using the PauTa criterion, to be used as the first membership degree matrix.

15. The derivation system according to claim 13, wherein the step of performing weight assignment on the various same-type evaluation indicator sub-items by utilizing the operation safety knowledge graph to obtain the first weight matrix, and constructing the evaluation indicator sub-item comprehensive evaluation matrix according to the first membership degree matrix and the first weight matrix comprises:
determining various special working conditions of concerned key parts for evaluating the concrete dam operation performance, wherein the special working conditions comprise close range strong earthquakes, catastrophic floods, and extreme low temperatures;
selecting the close range strong earthquakes, the catastrophic floods and the extreme low temperatures as input user items of the operation safety knowledge graph, using the special working conditions to drive the operation safety knowledge graph to activate evaluation indicators that are affected, and calculating weight scores of evaluation indicator sub-items under the various same-type evaluation indicators under the special working conditions, so as to obtain the first weight matrix; and
constructing the evaluation indicator sub-item comprehensive evaluation matrix according to the first membership degree matrix and the first weight matrix.
